(19) United States
(12) Patent Application Publication
(10) Pub. No.: US 2017/0017833 A1
(43) Pub. Date: Jan. 19, 2017

(54) VIDEO MONITORING SUPPORT APPARATUS, VIDEO MONITORING SUPPORT METHOD, AND STORAGE MEDIUM

(71) Applicant: HITACHI KOKUSAI ELECTRIC INC., Tokyo (JP)

(72) Inventors: Yuki WATANABE, Tokyo (JP); Atsushi HIROIKE, Tokyo (JP); Daisuke MATSUBARA, Tokyo (JP); Kenichi YONEJI, Tokyo (JP); Tomoaki YOSHINAGA, Tokyo (JP); Nobuo NUKAGA, Tokyo (JP); Seiichi HIRAI, Tokyo (JP); Yuichi ONAMI, Tokyo (JP)

(73) Assignee: HITACHI KOKUSAI ELECTRIC INC., Tokyo (JP)

(21) Appl. No.: 15/124,098

(22) PCT Filed: Mar. 3, 2015
(86) PCT No.: PCT/JP2015/056165

§ 371 Date: Sep. 7, 2016

(30) Foreign Application Priority Data
Mar. 14, 2014 (JP) 2014-052175

(51) Int. Cl. G06K 9/00; G06K 9/78; G06F 17/30; H04N 7/18

(52) U.S. Cl. CPC G06K 9/00288; G06K 9/00771; G06K 9/00718; H04N 7/181; G06K 9/78; G06K 9/00255; G06F 17/30256; G06F 17/30793

(57) ABSTRACT

This video monitoring support apparatus is provided with a processor and a storage device coupled to the processor. The storage device holds multiple images. The video monitoring support apparatus performs a similar image search, in which multiple images held in the storage device are searched for images similar to an image extracted from inputted video, outputs multiple recognition results, which include information relating to each of the images obtained by the similar image search, and controls the amount of the outputted recognition results to a predetermined value or less.

### CLAIM OF PRIORITY

The present application claims priority from Japanese patent application JP2014-52175 filed on Mar. 14, 2014, the content of which is hereby incorporated by reference into this application.

### BACKGROUND OF THE INVENTION

The present invention relates to a video monitoring support technique.

As monitoring cameras have become widespread, there has been an increasing need to search for a specific person, vehicle, or the like from video taken at multiple locations. However, many conventional monitoring camera systems are constituted of monitoring cameras, recorders, and playback devices, which means that in order to discover a specific person, a worker would have to check all persons and vehicles in the video, which places a large workload on the worker.

Systems that include image recognition techniques, and in particular, object detection and similar image searches have been garnering attention. By using image recognition techniques, it is possible to extract an object belonging to a specific category from an image. By using similar image search techniques, it is possible to compare a case image stored beforehand in a database with an image of the object extracted by the object extraction technique, thereby enabling one to guess the name, attribute information, or the like of the object. By using a system with image recognition, the worker need not check every single one of a large number of input images, but can prioritize confirmation of recognition results outputted by the system, which reduces workload. JP 2011-029737 A (Patent Document 1), for example, discloses an invention relating to a facial recognition system to be used on monitoring video using similar image search, the invention being a method that selects a face that can be easily confirmed visually from among images of the face of the same person in contiguous frames and displays the face in order to improve work efficiency.

### SUMMARY OF THE INVENTION

Patent Document 1 discloses an invention having the object of increasing efficiency of a first visual confirmation task. On the other hand, in video monitoring work in which video is taken constantly and continually, the amount of confirmation work to be done within a predetermined time, that is, the amount of image confirmation results displayed is a problem. If the amount of results displayed is beyond the processing capacity of the worker, then even if candidates are outputted from among the image confirmation results, this can result in an increase in instances of the worker overlooking the relevant image.

In order to solve at least one of the foregoing problems, there is provided a video monitoring support apparatus, comprising: a processor; and a storage device coupled to the processor, wherein the storage device stores a plurality of images, and wherein the video monitoring support apparatus is configured to: execute a similar image search in which an image similar to an image extracted from inputted video is searched from among the plurality of images stored in the storage device; output a plurality of recognition results including information pertaining to images acquired by the similar image search; and control an amount of the recognition results outputted so as to be at or below a predetermined value.

According to the video monitoring apparatus of the present invention, it is possible to reduce the workload of the worker and to prevent objects to be monitored from being missed. Problems, configurations, and effects other than what was described above are made clear by the description of embodiments below.

### BRIEF DESCRIPTION OF THE DRAWINGS

FIG. 1 is a function block diagram showing the configuration of a video monitoring support system according to Embodiment 1 of the present invention.

FIG. 2 is a block diagram showing the hardware configuration of the video monitoring support system according to Embodiment 1 of the present invention.

FIG. 3 is a descriptive drawing showing a configuration of an image database and a data example in Embodiment 1 of the present invention.

FIG. 4 is a drawing for describing the operation of an image recognition process performed by an image recognition unit using the image database 108 in the video monitoring support system of Embodiment 1 of the present invention.

FIG. 5 is a descriptive drawing of one example of a display method of a visual confirmation task to be performed by a monitoring worker when the video monitoring support system of Embodiment 1 of the present invention is applied to monitoring work on a specific person.

FIG. 6 is a drawing for describing the consolidation of recognition results used in object tracking, performed by the video monitoring support system of Embodiment 1 of the present invention.

FIG. 7A is a descriptive drawing showing a data flow from when video is inputted to the video monitoring support apparatus of Embodiment 1 of the present invention to when a visual confirmation task is displayed in the display device.

FIG. 7B is a descriptive drawing showing an example of operation parameters of the image recognition process that would be a cause for an increase or decrease in the number of visual confirmation tasks outputted by the video monitoring support apparatus according to Embodiment 1 of the present invention.

FIG. 8 is a flowchart describing a series of processes by which the video monitoring support apparatus of Embodiment 1 of the present invention performs image recognition by similar image search, and controls operation parameters for the recognition process in order to restrict the amount of recognition results displayed according to the amount of work done.

FIG. 9 is a drawing describing a process sequence of the video monitoring support system according to Embodiment 1 of the present invention.

FIG. 10 is a drawing that shows a configuration example of an operating screen for performing monitoring work aimed at finding a specific object being filmed using the video monitoring support apparatus of Embodiment 1 of the present invention.

FIG. 11 is a drawing for describing a non-chronological display method for visual confirmation tasks performed by a video monitoring support system of Embodiment 2 of the present invention.

FIG. 12 is a flowchart for describing the process of a non-chronological display method for visual confirmation tasks performed by the video monitoring support system of Embodiment 2 of the present invention.

FIG. 13 is a drawing for describing a display amount control method with independent video sources performed by a video monitoring support system of Embodiment 3 of the present invention.

FIG. 14 is a drawing for describing a consolidation method for visual confirmation tasks generated from video taken at a plurality of locations, performed by the video monitoring support system of Embodiment 3 of the present invention.

FIG. 15 is a flowchart for describing a consolidation method for visual confirmation tasks generated from video taken at a plurality of locations, performed by the video monitoring support system of Embodiment 3 of the present invention.

FIG. 16 is a drawing for describing a method for rejecting remaining tasks by clustering performed by a video monitoring support system of Embodiment 4 of the present invention.

FIG. 17 is a flowchart for describing a method for rejecting remaining tasks by clustering performed by the video monitoring support system of Embodiment 4 of the present invention.

FIG. 18 is a drawing that shows a configuration example of an operating screen for performing monitoring work aimed at finding a specific object being filmed using a video monitoring support apparatus of Embodiment 5 of the present invention.

### DETAILED DESCRIPTION OF EMBODIMENTS

### Embodiment 1

<System Configuration>

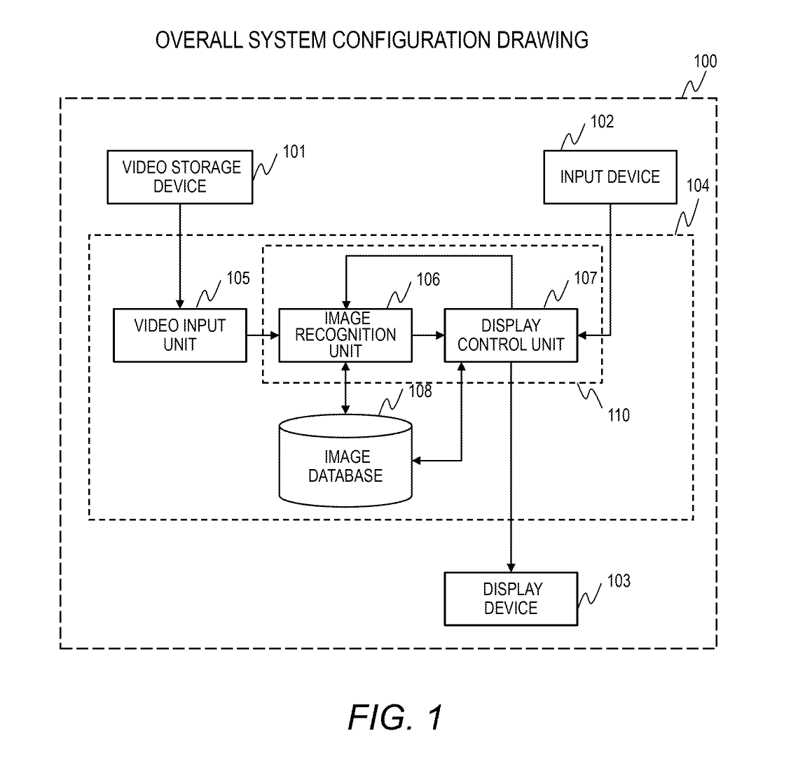

FIG. 1 is a function block diagram showing the configuration of a video monitoring support system 100 according to Embodiment 1 of the present invention.

The video monitoring support system 100 aims to reduce workload on a monitoring worker (user) by using a case image stored in an image database to automatically search and output an image of a specific object (a person or the like, for example) from inputted video.

The video monitoring support system 100 includes an image storage device 101, an input device 102, a display device 103, and a video monitoring support apparatus 104.

The video storage device 101 is a storage medium that stores one or more pieces of video data taken by one or more imaging devices (for example, monitoring cameras such as video or still frame cameras; not shown), and can be a hard disk drive installed in a computer or a network-connected storage system such as network attached storage (NAS) or a storage area network (SAN). The video storage device 101 may also be cache memory that temporarily stores video data continuously inputted from a camera, for example.

The video data stored in the video storage device 101 may be in any format as long as chronology information of the images can be acquired in some form. For example, the stored video data may be video data taken by a video camera or a series of still frame image data taken over a predetermined period by a still frame camera.

If a plurality of pieces of video data taken by a plurality of imaging devices are stored in the video storage device 101, the pieces of video data may respectively include information identifying the imaging device that took the video (such as a camera ID; not shown).

The input device 102 is an input interface such as a mouse, keyboard, or touch device for transmitting user operations to the video monitoring support apparatus 104. The display device 103 is an output interface such as a liquid crystal display that is used in order to display recognition results from the video monitoring support apparatus 104, interactive operations with the user, or the like.

The video monitoring support apparatus 104 detects a specific object included in each frame of the provided video data, consolidates the information, and outputs the information to the display device 103. The outputted information is displayed to the user by the display device 103. The video monitoring support apparatus 104 observes the amount of information presented to the user and the amount of work that the user does in relation to the amount of information displayed, and dynamically controls image recognition such that the amount of work given to the user is at or below a predetermined amount. The video monitoring support apparatus 104 includes a video input unit 105, an image recognition unit 106, a display control unit 107, and an image database 108.

The video input unit 105 reads in video data from the video storage device 101 and converts it to a data format that can be used in the video monitoring support apparatus 104. Specifically, the video input unit 105 performs a video decoding process that divides the video (video data format) into frames (still image data format). The obtained frames are sent to the image recognition unit 106.

The image recognition unit 106 detects an object of a predetermined category from the images provided by the video input unit 105 and determines the unique name of the object. If, for example, the system is designed to detect a specific person, then the image recognition unit 106 first detects a facial region from the image. Next, the image recognition unit 106 extracts an image characteristic amount (face characteristic amount) from the facial region and compares it to a face characteristic amount recorded beforehand in the image database 108, thereby determining the person's name and other attributes (such as gender, age, race). Also, the image recognition unit 106 tracks the same object appearing in consecutive frames and consolidates the recognition results of a plurality of frames to a single recognition result. The obtained recognition result is sent to the display control unit 107.

The display control unit 107 processes the recognition result obtained from the image recognition unit 106 and further acquires information on the object from the image database 108, thereby generating an image to be displayed to the user and outputting the image. As described below, the user refers to the displayed image to perform a predetermined task. The predetermined task involves the user determining whether the object in the image obtained as the recognition result is the same as the object in the image used for performing a similarity search to obtain the image (that is, an image determined to be similar to an image obtained by the image recognition unit 106 as a recognition result), and inputting the result thereof. If the amount of recognition results outputted during a predetermined time is at or above a certain amount, then the display control unit 107 controls the image recognition unit 106 to reduce the amount of image recognition results. Alternatively, the display control unit 107 may control the image recognition unit 106 so as to reduce the amount of outputted recognition results on the basis of a predetermined condition instead of outputting all recognition results sent from the image recognition unit 106. The display control unit 107 may control the amount of recognition results outputted during a predetermined time so as to be at or below an amount designated by the user, or the display control unit 107 may observe the amount of work done by the user to dynamically control the amount of recognition results outputted on the basis of the amount of work done, for example.

As described above, the image recognition unit 106 and the display control unit 107 are used to control the flow of recognition results displayed to the user. The image recognition unit 106 and display control unit 107 are sometimes collectively referred to below as a flow control display unit 110.

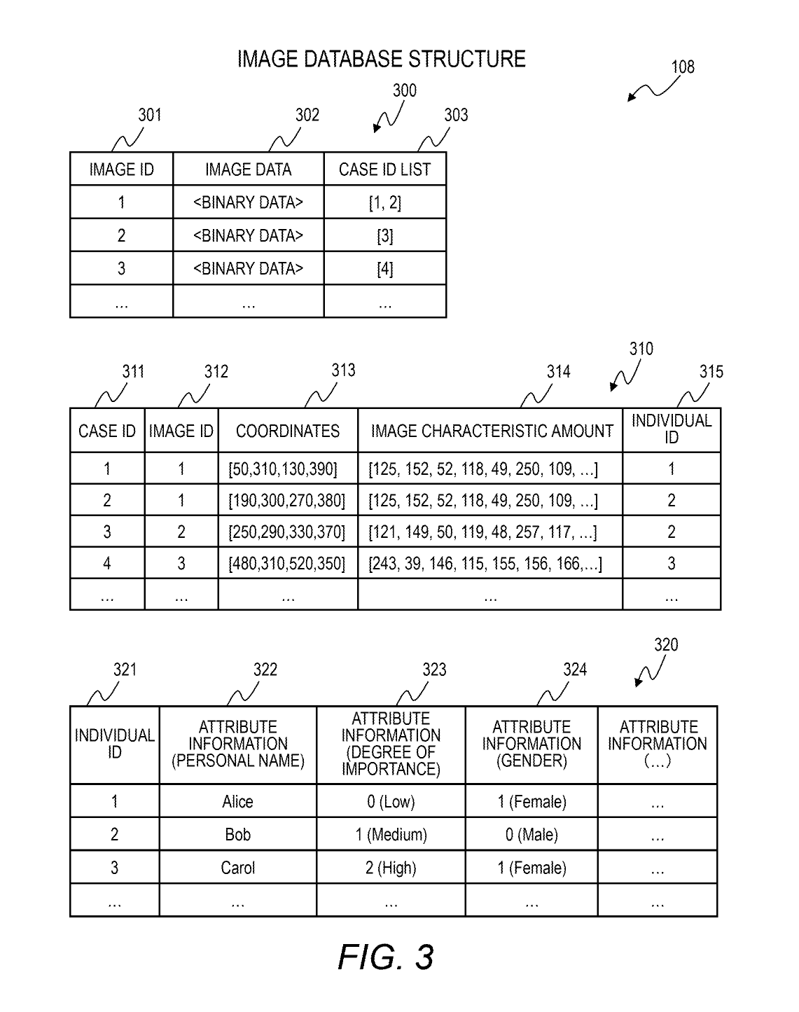

The image database 108 is a database for managing image data, object cases, and individual information of the object necessary for image recognition. The image database 108 stores an image characteristic amount, and the image recognition unit 106 can perform a similar image search using the image characteristic amount. The similar image search is a function of outputting data in order of greater similarity of the image characteristic amount to the query. It is possible to use the Euclidean distance between vectors, for example, for comparison of image characteristic amounts. The image database 108 stores in advance an object to be recognized by the video monitoring support system 100. The image database 108 is accessed when the image recognition unit 106 performs a search process and when the display control unit 107 performs an image acquisition process. The structure of the image database 108 will be described in detail later together with FIG. 3.

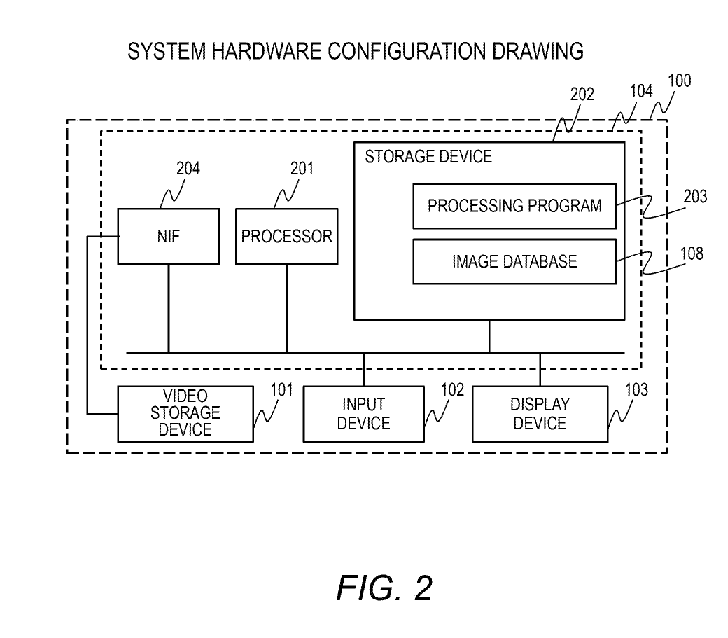

FIG. 2 is a block diagram showing the hardware configuration of the video monitoring support system 100 according to Embodiment 1 of the present invention.

The video monitoring support apparatus 104 can be a general computer, for example. The video monitoring support apparatus 104 may have a processor 201 and a storage device 202 connected to each other, for example. The storage device 202 is constituted of a storage medium of any type. The storage device 202 may be configured by combining a semiconductor memory with a hard disk drive, for example.

In this example, function units such as the video input unit 105, the image recognition unit 106, and the display control unit 107 shown in FIG. 1 are realized by the processor 201 executing processing programs 203 stored in the storage device 202. In other words, in this example, the processes executed by the respective function units are in reality executed by the processor 201 on the basis of the processing programs 203. The image database 108 is included in the storage device 202.

The video monitoring support apparatus 104 further includes a network interface device 204 (NIF) connected to the processor. The video storage device 101 may be an NAS or SAN connected to the video monitoring support apparatus 104 through the network interface device 204. Alternatively, the video storage device 101 may be included in the storage device 202.

FIG. 3 is a descriptive drawing showing a configuration of the image database 108 and a data example in Embodiment 1 of the present invention. Here, a configuration example of a table format is shown but any data format may be used for the image database 108.

The image database 108 includes an image table 300, a case table 310, and an individual information table 320. The table configuration and field configuration of each table in FIG. 3 is the minimum configuration necessary for implementing the present invention, and tables and fields may be added according to the application. The table configuration of FIG. 3 is an example of a case in which the video monitoring support system 100 is geared towards monitoring specific persons, and uses information such as the face and attributes of a person to be monitored as an example of fields and data in the table. Explanations will be made below according to this example. However, the video monitoring support system 100 can also be geared towards monitoring of objects other than persons, and in such a case, it is possible to use information pertaining to the parts and attributes of the object appropriate for monitoring the object.

The image table 300 has an image ID field 301, an image data field 302, and a case ID list field 303. The image ID field 301 retains an identification number for each piece of image data. The image data field 302 is binary data of a still image and retains data to be used when outputting recognition results to the display device 103. The case ID list field 303 is a field for managing lists of cases present in an image, and retains a list of IDs to be managed by the case table 310.

The case table 310 has a case ID field 311, an image ID field 312, a coordinate field 313, an image characteristic amount field 314, and an individual ID field 315. The case ID field 311 retains an identification number for each piece of case data. The image ID field 312 retains the image IDs managed by the image table 300 for referring to the images included in the cases. The coordinate field 313 retains coordinate data representing a position of the case in the image. The coordinate of the case is expressed in the format of “upper left corner horizontal coordinate, upper left corner vertical coordinate, lower right corner horizontal coordinate, lower right corner vertical coordinate of a rectangle” of a circumscribed rectangle of the object, for example. The image characteristic amount field 314 retains the image characteristic amount extracted from the case image. The image characteristic amount is expressed as a vector of a fixed length, for example. The individual ID field 315 retains individual IDs managed by the individual information table 320 in order to associate the case with the individual information.

The individual information table 320 has an individual ID field 321 and one or more attribute information fields. In the example of FIG. 3, a personal name field 322, an importance field 323, and a gender field 324 are provided as attribute information for an individual (that is, a person). The individual ID field 321 retains an identification number for each piece of individual information data. The attribute information field retains data that is individual attribute information expressed in any format such as a character array or a number. In FIG. 3, the personal name field 322 retains the name of a person as a character array, the importance field 323 retains the degree of importance of a person as a numerical value, and the gender field 324 retains the gender of the person as a numerical value.

In the case table 310 in FIG. 3, the image ID fields 312 of the first and second records store the same value “1”, and the individual ID fields 315 for the same records store “1” and “2”, respectively, for example. This indicates that one image identified by the image ID “1” includes an image of two persons (such as an image of faces of these persons) identified by individual IDs “1” and “2”. In other words, the coordinate field 313 and the image characteristic amount field 314 of these records retain coordinates of the range of facial images for the persons and the characteristic amounts of the facial images.

On the other hand, in the case table 310 in FIG. 3, the individual ID fields 315 of the second and third records store the same value “2”, the case ID fields 311 for the same records store “2” and “3”, respectively, and the image ID fields 312 for the same records store “1” and “2”, respectively, for example. This indicates that images of one person identified by the individual ID “2” include two images identified by image IDs “1” and “2”. The image identified by the image ID “1” may include a frontal facial image of the person with the image identified by the image ID “2” including a profile facial image of the person, for example. In this case, the coordinate field 313 and image characteristic amount field 314 corresponding to the case ID “2” retains coordinates indicating the range in the image of the frontal facial image of the person and the image characteristic amount for the front view of the face, and the coordinate field 313 and image characteristic amount field 314 corresponding to the case ID “3” retain coordinates indicating the range in the image of the profile facial image of the person and the image characteristic amount of the profile view of the face.

<Operation of Each Part>

Above, the overall configuration of the video monitoring support system 100 was described. Below, after making a general description of the operating principles of the video monitoring support system 100, a detailed operation of each function unit will be made.

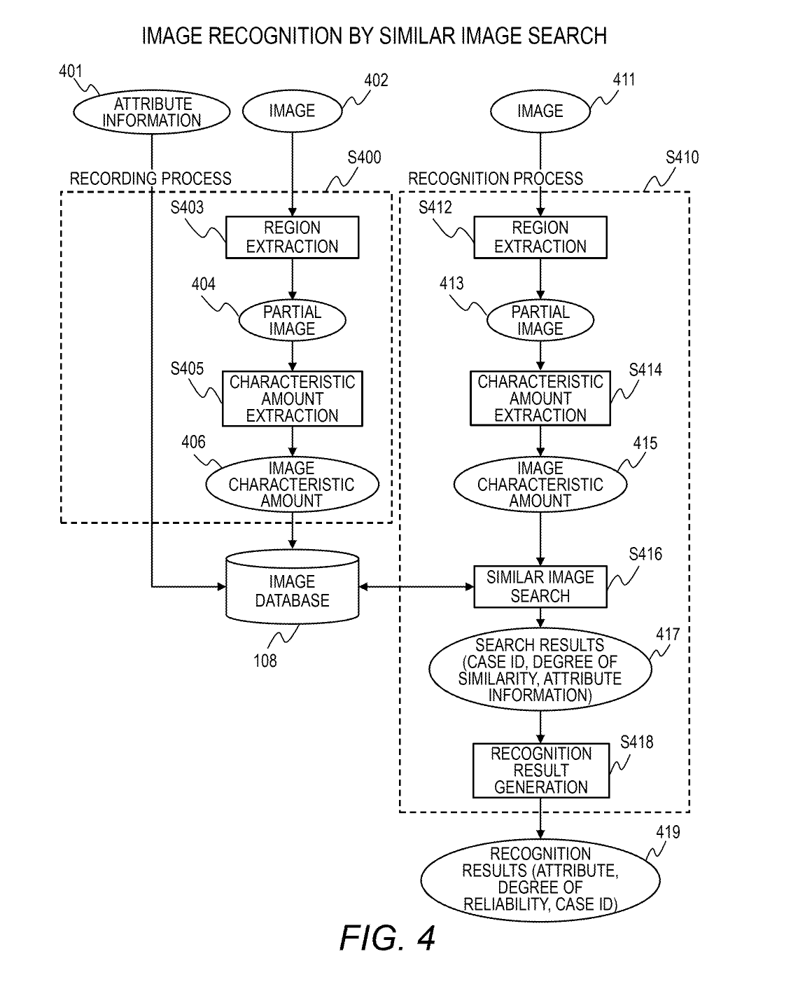

FIG. 4 is a drawing for describing the operation of an image recognition process performed by the image recognition unit 106 using the image database 108 in the video monitoring support system 100 of Embodiment 1 of the present invention. In the drawing, the ellipse indicates data and the rectangle indicates process steps.

Image recognition employing similar image search includes a recording process S400, which is a pre-process, and a recognition process S410 performed during operation.

In the recording process S400, attribute information 401 and an image 402 are provided as input, and are added as case data to the image database 108. First, the image recognition unit 106 performs region extraction S403 to extract a partial image 404 from the image 402. The region extraction S403 performed during recording may be performed manually by the user or automatically by image processing. Any publicly known method can be used for the image characteristic amount extraction method. If an image characteristic amount extraction method that does not require region extraction is to be used, then the region extraction S403 may be omitted.

Next, the image recognition unit 106 performs characteristic amount extraction S405 to extract the image characteristic amount 406 from the extracted partial image 404. The image characteristic amount is numerical data expressed as a vector of a fixed length, for example. Lastly, the image recognition unit 106 associates the attribute information 401 with the image characteristic amount 406 and records these in the image database 108.

In the recognition process S410, an image 411 is provided as input, and a recognition result 419 is generated using the image database 108. First, similar to the recording process S400, the image recognition unit 106 performs region extraction S412 to extract a partial image 413 from the image 411. In the recognition process S410, the region extraction S412 is generally executed automatically by image processing. Next, the image recognition unit 106 performs characteristic amount extraction S414 to extract the image characteristic amount 415 from the extracted partial image 413. Any method can be used for image characteristic amount extraction, but this extraction must be performed using the same algorithm as during recording.

In a similar image search S416, the image recognition unit 106 searches, from among cases recorded in the image database 108, the case with the highest degree of similarity to the query, which is the extracted image characteristic amount 415. The smaller the distance between characteristic amount vectors, the higher the degree of similarity is, for example. During similar image search S416, search results 417 including a set of one or more case IDs, degree of similarity, attribute information, and the like from the image database 108 are outputted.

Lastly, in recognition result generation S418, the image recognition unit 106 uses the search results 417 to output recognition results 419. The recognition results 419 include the attribute information, the reliability of recognition results, and a case ID, for example. The reliability of recognition results may be a value indicating the degree of reliability calculated in the similar image search S416, for example. The method for generating recognition results can employ attribute information of the one search result with the highest degree of similarity and nearest neighbor search, which employs this degree of similarity. If the degree of reliability of the one recognition result with the highest degree of similarity is at or below a predetermined value, then the recognition result may not be outputted.

By using the recognition process S410 described above, it is possible to create a system that performs a predetermined operation automatically, with the passing of an object such as a person recorded in the image database 108 into the imaging range of an imaging device as a trigger. However, generally image recognition accuracy in monitoring video analysis is low, which raises the risk of the system undergoing a glitch due to mistaken information, and thus, in reality, there are many cases in which after the user performs a final visual confirmation, image recognition is used in supporting the user by executing a predetermined operation. The video monitoring support system 100 of the present invention also aims to increase the efficiency of visual confirmation tasks by the user, and has a display function that, instead of automatically controlling the system using image recognition results described in FIG. 4, displays image recognition results in order to request that the user perform visual confirmation on the results.

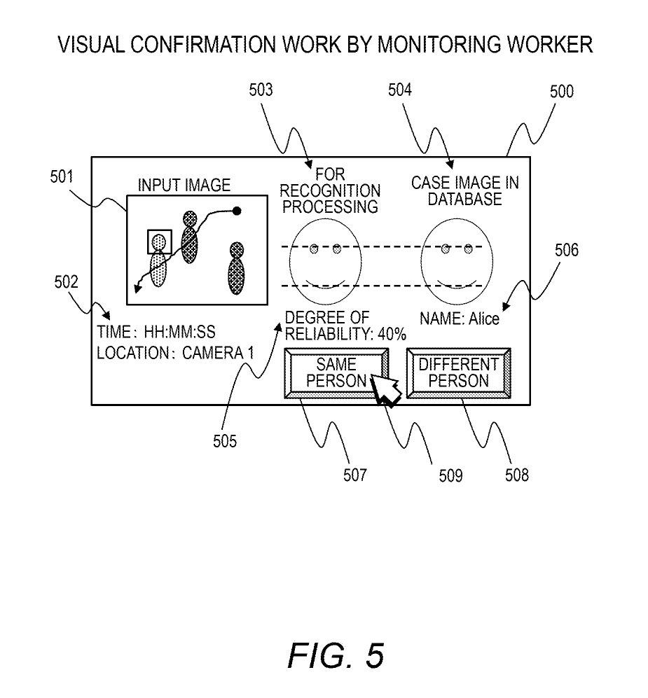

FIG. 5 is a descriptive drawing of one example of a display method of a visual confirmation task to be performed by a monitoring worker when the video monitoring support system 100 of Embodiment 1 of the present invention is applied to monitoring work on a specific person.

In the video monitoring support apparatus 104, when image recognition results are outputted from the image recognition unit 106, the display control unit 107 generates a visual confirmation task display screen 500. The visual confirmation task display screen 500 has a frame display region 501, a frame information display region 502, a confirmation process target display region 503, a case image display region 504, a reliability display region 505, an attribute information display region 506, a recognition result accept button 507, and a recognition result reject button 508.

The frame display region 501 is a region for displaying a frame for which image recognition results were attained. Only the frame for which recognition results were attained may be displayed or a video may be displayed including a few frames before and after. The recognition results may overlap the video. The rectangle of the person's face region and movement lines of the person may be drawn, for example.

In the frame information display region 502, the time at which the image recognition results were attained, information on the camera where the frame was acquired, and the like are displayed. The confirmation process target display region 503 displays the image of an object extracted from the frame, magnifying the image to a size that facilitates confirmation by the user. The case image display region 504 reads the case image used in image recognition from the image database 108 and displays it. The user visually confirms the image displayed in the confirmation process target display region 503 and the case image display region 504 and makes a determination, and thus, additional lines may be added, the image resolution may be increased, the orientation of the image may be corrected, or the like, as necessary.

The degree of reliability and attribute information of the image recognition results are, respectively, displayed in the reliability display region 505 and the attribute information display region 506. The user looks at the images displayed in these regions and determines whether or not the recognition results are correct, that is, whether or not the images point to the same person. If the user determines that the recognition results are correct, then he/she operates a mouse cursor 509 using the input device 102 and clicks the recognition result accept button 507. If the recognition results are mistaken, then the user clicks on the recognition result reject button 508. The determination results by the user may be transmitted from the input device 102 to the display control unit 107 and, as necessary, further transmitted to an external system.

By applying the recognition process S410 described above to each frame of the input video, it is possible to notify the user that an object having specific attributes has appeared in the video. However, if a recognition process is performed for each frame, then this results in similar recognition results being displayed several times for the same object appearing in consecutive frames, which increases the workload on the user to confirm the recognition results. However, in such a case, the user actually need only confirm one or a few of a plurality of images of the same object appearing in consecutive frames. In the video monitoring support system 100, by performing a tracking process to associate the object to multiple frames, the recognition results are consolidated and outputted.

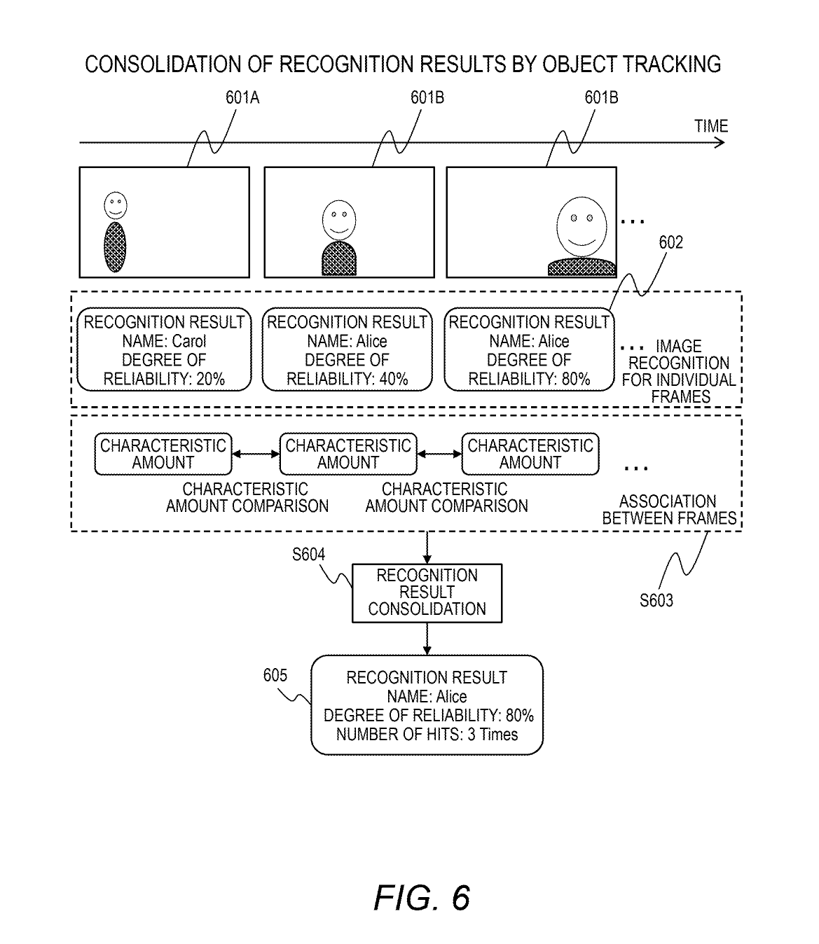

FIG. 6 is a drawing for describing the consolidation of recognition results used in object tracking, performed by the video monitoring support system 100 of Embodiment 1 of the present invention.

When consecutive frames (frames 601A to 601C, for example) are inputted from the video input unit 105, the image recognition unit 106 performs image recognition by the method in FIG. 4 and generates recognition results 602 for each frame.

Next, the image recognition unit 106 compares the characteristic amounts of the objects in the frames, thereby associating an object with the frames (that is, performing the tracking process) (S603). By comparing the characteristic amounts of a plurality of images included in a plurality of frames, for example, the image recognition unit 106 determines whether the images have the same object. In this case, the image recognition unit 106 may use information other than characteristic amounts used in the recognition process. If the object is a person, for example, characteristics of the person's clothes may be used in addition to facial characteristic amounts. Physical restrictions may also be used in addition to characteristic amounts. The image recognition unit 106 may limit the search range in the corresponding face to a certain range (pixel length) in the image, for example. Physical restrictions can be calculated by the camera imaging range, the video frame rate, the maximum movement speed of the object, and the like.

As a result, it is possible for the image recognition unit 106 to determine that objects having similar characteristic amounts across multiple frames are the same individual (same person, for example), and consolidate these into a single recognition result (605). In recognition result consolidation S604, the image recognition unit 106 may adopt the recognition result with the highest reliability among the recognition results of the respective associated frames, or weight the recognition results according to reliability.

A specific example of consolidation will be described with reference to FIG. 6. Here, an example is illustrated in which the facial characteristic amount is used. If an image of a person is included in frames 601A to 601C, the image recognition unit 106 generates recognition results 602 per frame by comparing each of the images extracted from the frames with an image retained in the image database 108. As a result, the image extracted from the frame 601A is determined to be most similar to an image of a person whose name is “Carol” and that the degree of reliability is 20%. The images extracted from the frames 601B and 601C are both determined to be most similar to an image of a person whose name is “Alice” and the degrees of reliability are, respectively 40% and 80%.

Meanwhile, the image recognition unit 106, upon comparing the characteristic amounts of the faces of the images of the persons extracted from the images in frames 601A to 601C in S603, has determined that the characteristic amounts are similar, and thus, the images of persons in frames 601A to 601C are in fact images of the same person. In such a case, the image recognition unit 106 outputs a predetermined number of recognition results with the highest degree of reliability (one recognition result with the highest degree of reliability, for example), and does not output the other recognition results. In the example of FIG. 6, only the recognition result of frame 601C is outputted.

The image recognition process for each frame and the tracking process using past frames described above are performed every time a new frame is inputted and recognition results are updated, which allows the user to visually confirm only the most reliable recognition result as of that time, enabling a reduction in workload. However, even if such a consolidation process as described above is performed, if monitoring a location with a large amount of traffic or monitoring a plurality of locations simultaneously, the number of confirmation tasks presented to the user is large. In monitoring work, if more confirmation tasks are presented than the user can handle, this presents an increased risk of the user overlooking important information. The video monitoring support system 100 of the present invention increases the efficiency of monitoring work by restricting the amount of confirmation tasks presented to the user to at or below a predetermined amount.

In the video monitoring support apparatus 104 of the present invention, the display control unit 107 monitors the work progress of the user, and dynamically controls operation parameters of the image recognition unit 106 according to the work amount and the current task flow amount (amount of new tasks generated per unit time). In order to restrict the task flow amount, there is a need to estimate the video state (imaging conditions, traffic amount) during operation as well as the worker's processing capabilities, which means that it is difficult to adjust operation parameters for image recognition prior to the start of operations. A characteristic of the present invention is that by restricting the visual confirmation workload for the worker to a predetermined value, it is possible to control image recognition processing adaptively.

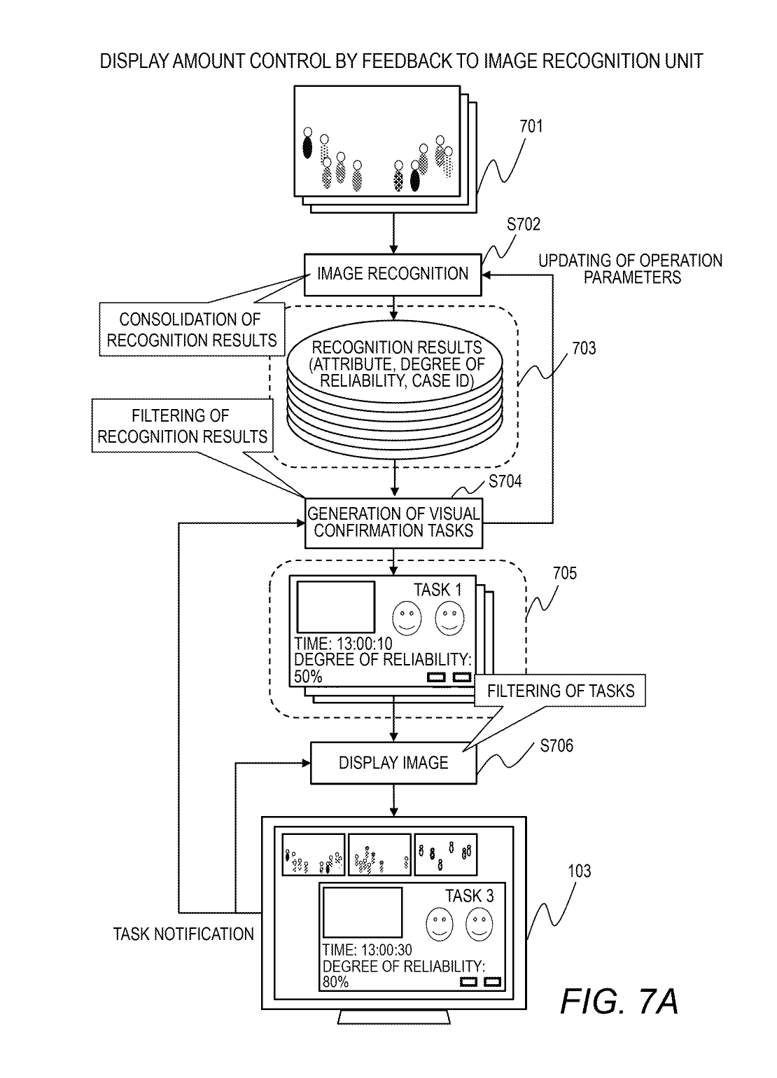

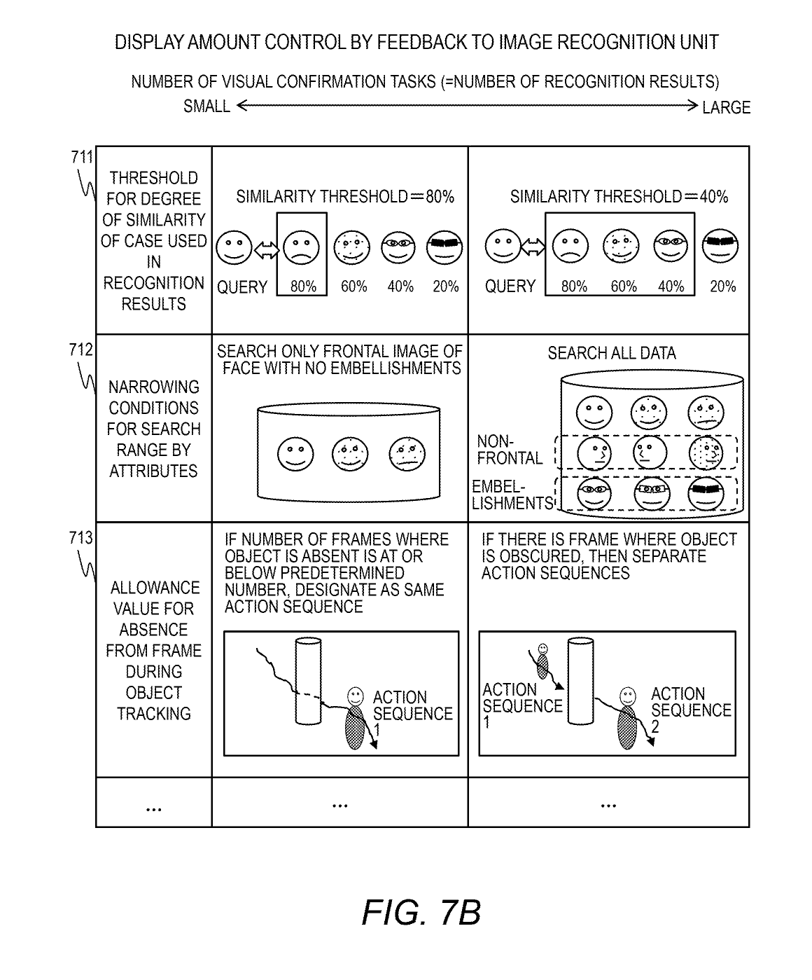

FIG. 7A is a descriptive drawing showing a data flow from when video is inputted to the video monitoring support apparatus 104 of Embodiment 1 of the present invention to when a visual confirmation task is displayed in the display device 103.

When a frame 701 of video is extracted by the video input unit 105, the image recognition unit 106 performs the image recognition process and generates recognition results 703 (S702). The content of the image recognition process S702 is as described with reference to FIGS. 4 and 6.

The display control unit 107 filters the recognition results such that the amount of recognition results is at or below a predetermined amount set in advance or is at or below an amount derived from the working speed of the user acquired during operation (S704). By controlling image recognition parameters and not after generation of recognition results, it is possible to adjust the quantity of recognition results generated by the image recognition unit 106. The method of controlling operation parameters will be mentioned later in the description of FIG. 7B. The display control unit 107 generates a visual confirmation task 705 from the filtered recognition results.

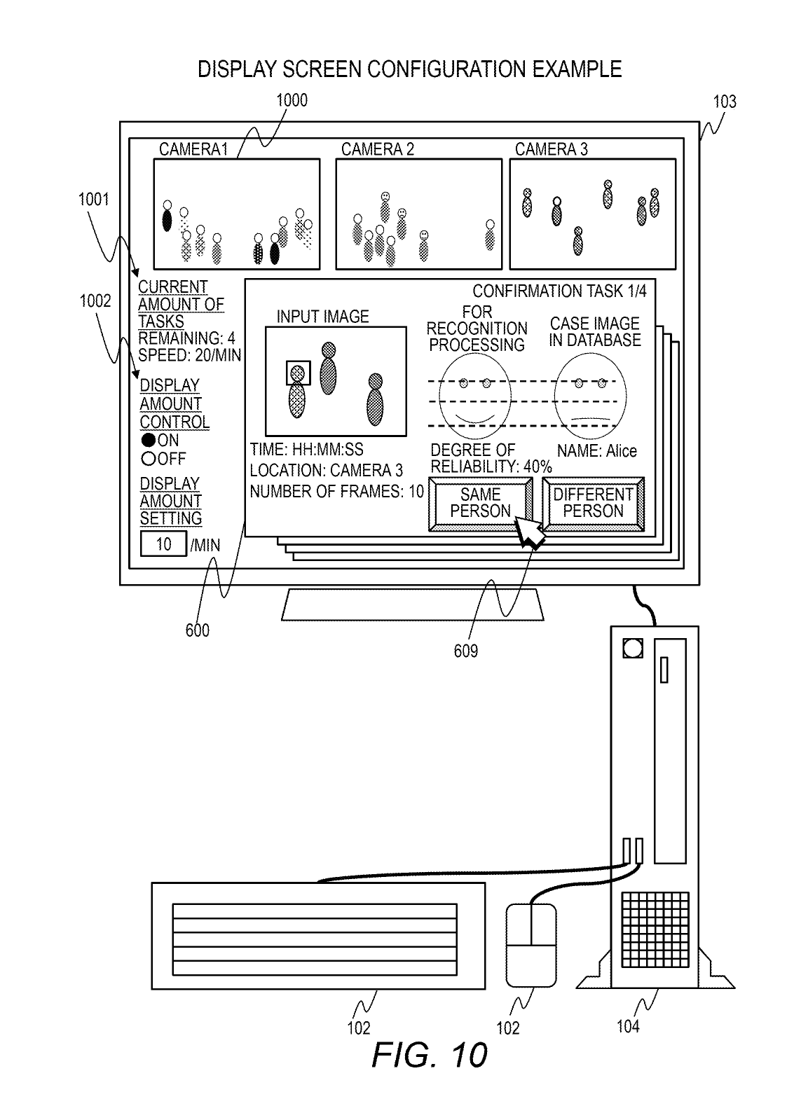

The display control unit 107 displays visual confirmation tasks 705 one after the other in the display device 103 according to the work performed by the user (S706). The work content of the user is issued as a notification to the display control unit 107 and used in controlling the amount of results displayed thereafter. The determination results by the user, described with reference to FIG. 5, correspond to the work content of the user, issued as a notification. Details of the operation process will be mentioned later in describing FIG. 10.

When the display control unit 107 outputs a predetermined number (one or more) of visual confirmation tasks 705 to the display device 103 and simultaneously displays them, and user work content (that is, visual confirmation results) for any of the visual confirmation tasks 705 is issued as a notification, tasks for which visual confirmation by the user was completed may be deleted with the display control unit 107 instead displaying new visual confirmation tasks 705 in the display device 103, for example. If, when new visual confirmation tasks 705 are generated, user work content for older visual confirmation tasks 705 generated previously has not been issued, this indicates that the user has not yet completed the visual confirmation task for the older visual confirmation tasks 705, and thus, the display control unit 107 stores the newly generated visual confirmation tasks 705 in the storage device 202 without immediately outputting them. When user work content for the old visual confirmation tasks 705 is issued, the display control unit 107 outputs the visual confirmation tasks 705 stored in the storage device 202. The storage device 202 can store one or more visual confirmation tasks 705 that have been generated in this manner and are awaiting output.

FIG. 7B is a descriptive drawing showing an example of operation parameters of the image recognition process that would be a cause for an increase or decrease in the number of visual confirmation tasks outputted by the video monitoring support apparatus 104 according to Embodiment 1 of the present invention.

The operation parameters include, for example, a threshold 711 for the degree of similarity of a case used in recognition results, narrowing conditions 712 for a search range by attributes, and an allowance value 713 for absence from the frames during object tracking.

If the threshold 711 for the degree of similarity to a case used in recognition results is raised, this results in a decrease in the number of cases used from among the search results, which in turn results in a decrease in the number of candidate individuals added as results to the recognition results.

The number of recognition results having a degree of reliability of 80% or greater is less than the number of recognition results having a degree of reliability of 40% or greater, for example. The lower the degree of reliability is, the lower the probability that the image searched from the image database 108 is of the same object as in an inputted image. That is, there is a low probability that the inputted image is of the object being monitored. Thus, while it is preferable that the user also visually confirm images with a low degree of reliability if the user has the processing capabilities to do so, if that is not the case, then by excluding from visual confirmation images with a low degree of reliability, it is possible for the user's processing capabilities to be dedicated to confirmation of images that have a high probability of including the object being monitored. Thus, it is possible to anticipate that overlooking of images containing the object being monitored will be prevented.

By providing narrowing conditions 712 for the search range by attribute, only cases that match conditions well remain among the search results, which can reduce the amount and difficulty of the visual confirmation task.

There are cases, as shown in the case table 310 of FIG. 3, in which images of a plurality of cases of the same object are stored in the image database 108, for example. If the images of the plurality of cases are, for example, frontal images, non-frontal images (profile, for example), or images of faces with embellishments (such as eyeglasses), then it is thought that compared to the number of recognition results when a similar image search is performed on all of those images, the number of recognition results would be less when only a portion of those images (only one, for example) are searched. If the user's processing capabilities are insufficient, then by only searching images of a portion of the cases, it is possible to reduce the amount of visual confirmation tasks (that is, the amount of work to be done by the user). At this time, if a case thought to be easy to confirm (a frontal view of a face with no embellishments, for example) is selected to be searched, then the user can dedicate all of his/her processing capabilities to easier to confirm images, preventing overlooking of images of objects being monitored.

In order to select a case to be used for search as described above, the case table 310 may include information indicating attributes of each case (such as a front image of a face, a non-front image of a face, a face with embellishments, or clothes, for example), or information indicating the priority at which the image is selected for search. In the case of the latter, when frontal images of the face are given a higher priority than non-frontal images of the face to reduce the amount of visual confirmation tasks, for example, then only images of cases having a high degree of priority may be selected for search.

The allowance value 713 for absence from frames during object tracking is a parameter determining whether to associate an object that has reappeared with an object prior to being obscured, even if the object were hidden from view for a few frames by another object and therefore not detected, for example. If the allowance value is raised, then even if the object is absent from some of the frames, the object would be processed in the same sequence of movement. In other words, as a result of an increase in images determined to be of the same object, consolidation results in a decrease in the number of images used as search queries, resulting in a decrease in recognition results being generated. On the other hand, by decreasing the allowable range, the sequence of movement of an object prior to being obscured by another object and the sequence of movement of the object after reappearing are processed separately, resulting in a plurality of recognition results being generated.

Specifically, the image recognition unit 106 may, for the purposes of consolidation, compare an image of an object extracted from one frame with an image of the object extracted in the immediately previous frame, and in addition to that, may compare the object extracted from the one frame to an object extracted from two or more frames. The greater the number of images being compared (that is, comparison with older frames) is, the greater the allowance value 713 for absence from the frames is for object tracking, which reduces the amount of visual confirmation tasks as a result of consolidation. If the user's processing capabilities are insufficient, then by increasing the allowance value 713 for absence from the frame during object tracking, it is possible for the user to dedicate his/her processing capabilities to recognition results for images having a low probability of having the same object as another image, which enables prevention of overlooking of images containing objects being monitored.

The mode of control for the allowance value 713 for absence from the frame described above is one example of a mode of control of conditions for determining whether the plurality of images extracted from a plurality of frames contain the same object. Conditions for determining whether the plurality of images extracted from the plurality of frames contain the same object may be controlled by controlling parameters other than what was described above, such as a similarity threshold for image characteristic amounts used during object tracking.

One example of display amount control other than what was described above include selecting as recognition results either of logical conjunctions or logical disjunctions of results of a similarity search performed on a plurality of cases. A configuration may be adopted in which if, for example, an image of a certain person is inputted and the recognition results from when an image of the face extracted from the inputted image is the search query include the same person as recognition results for when a clothes image extracted from that image is the search query, the person is outputted as the recognition results, whereas if the persons differ from each other then the recognition results are not outputted, or separate recognition results may be outputted even when the persons differ from each other. The former results in fewer recognition results (that is, the amount of visual confirmation tasks being generated) being outputted than for the latter.

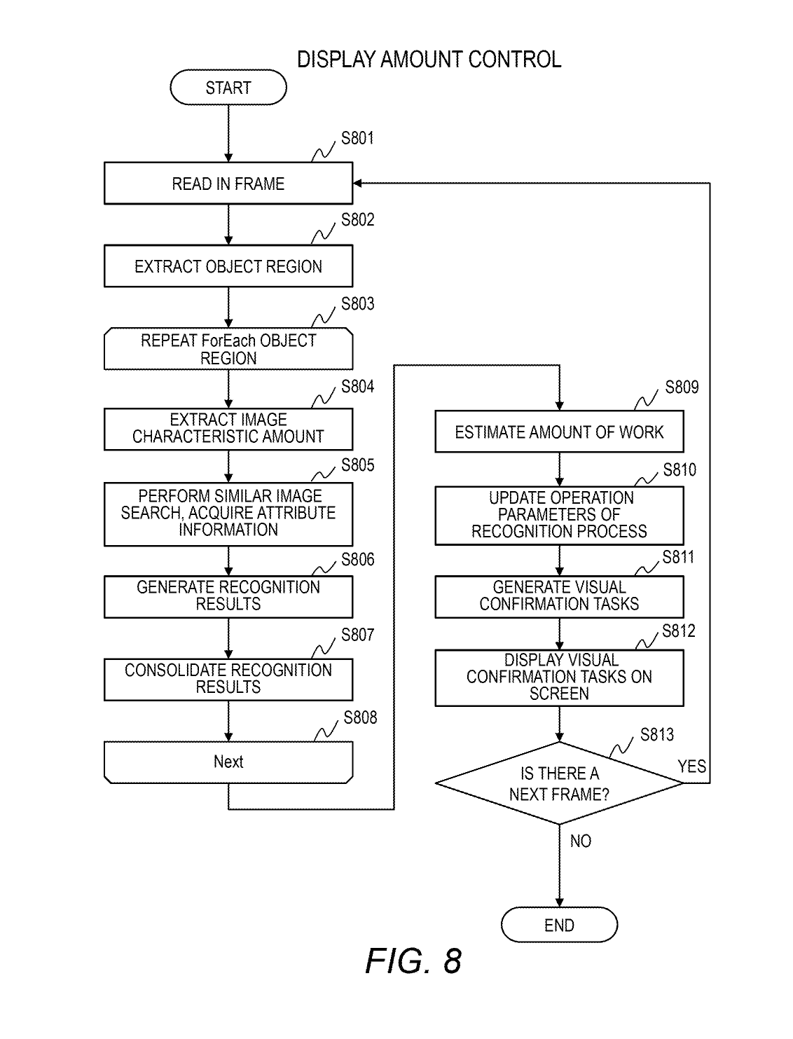

FIG. 8 is a flowchart describing a series of processes by which the video monitoring support apparatus 104 of Embodiment 1 of the present invention performs image recognition by similar image search, and controls operation parameters for the recognition process in order to restrict the amount of recognition results displayed according to the amount of work done. The respective steps of FIG. 8 will be described below.

(FIG. 8: Step S801)

The video input unit 105 acquires video from the video storage device 101 and converts it to a format that can be used in the system. Specifically, the video input unit 105 decodes the video and extracts frames (still images).

(FIG. 8: Step S802)

The image recognition unit 106 detects an object region in the frames obtained in step S801. Detection of the object region can be performed by a publicly known image processing method. In step S802, a plurality of object regions are obtained within the frame.

(FIG. 8: Steps S803-S808)

The image recognition unit 106 executes steps S803 to S808 for the plurality of object regions obtained in step S803.

(FIG. 8: Step S804)

The image recognition unit 106 extracts the image characteristic amount from the object regions. The image characteristic amount is numerical data expressing visual characteristics of the image such as color or shape, for example, and is vector data of a fixed length.

(FIG. 8: Step S805)

The image recognition unit 106 performs a similar image search on the image database 108 with the image characteristic amount obtained in step S804 as the query. The results of the similar image search are outputted in order of similarity with the case ID, degree of similarity, and attribute information of the case as a set.

(FIG. 8: Step S806)

The image recognition unit 106 generates image recognition results using the similar image search results obtained in step S805. The method for generating the image recognition results is as previously described with reference to FIG. 4.

(FIG. 8: Step S807)

The image recognition unit 106 associates the image recognition results generated in step S806 with previous recognition results, thereby consolidating the recognition results. The method for consolidating the recognition results is as previously described with reference to FIG. 6.

(FIG. 8: Step S809)

The display control unit 107 estimates the amount of work done by the user per unit time according to the amount of visual confirmation work performed by the user using the input device 102, and the amount of newly generated recognition results. The display control unit 107 may use the number of work content notifications by the user received per unit time (see FIG. 7A) as the estimate for the amount of work performed by the user per unit time, for example.

(FIG. 8: Step S810)

The display control unit 107 updates the operation parameters of the image recognition unit 106 according to the amount of work performed by the user per unit time obtained in step S809. An example of operation parameters to be controlled is as previously described with reference to FIG. 7B. If the amount of recognition results newly generated within a unit time exceeds a predetermined value, then the display control unit 107 may update the operation parameter of the image recognition unit 106 so as to lower the number of recognition results generated (that is, to reduce the number of visual confirmation tasks to be performed on the recognition results), for example. In this manner, the amount of recognition results generated and outputted is controlled so as not to exceed the predetermined value.

At this time, the predetermined value to which the amount of recognition results newly generated per unit time is compared may be set to be larger, the greater the amount of work performed by the user per unit period is, on the basis of the amount of work performed by the user per unit time as estimated in step S809. Specifically, the predetermined value may, for example, be the same as the amount of work performed by the user per unit time. Alternatively, the predetermined value may be a value manually set by the user (see FIG. 10).

(FIG. 8: Step S811)

The display control unit 107 generates a display screen of visual confirmation tasks. If necessary, the display control unit 107 acquires case information by accessing the image database 108. The configuration example of the display screen is as previously described with reference to FIG. 5.

(FIG. 8: Step S812)

The display control unit 107 outputs the visual confirmation tasks to the display device 103, and the display device 103 displays the visual confirmation tasks on the display screen. The display device 103 may simultaneously display a plurality of visual confirmation tasks.

In reality, the visual confirmation tasks generated in step S811 may not be immediately displayed in step S812 and may be stored temporarily in the storage device 202, as described with reference to FIG. 7A. If a plurality of visual confirmation tasks are stored in the storage device 202, then these form a queue.

(FIG. 8: Step S813)

If input of the next frame is received from the video storage device 101, the video monitoring support apparatus 104 returns to step S801 and continues to execute the above processes. Otherwise, the process is ended.

The steps of the process above constitute one example, and in reality, various modification examples are possible. For example, step S813 may be executed by the image recognition unit 106 not after step S812 but between step S808 and step S809. In such a case, only recognition results with a high degree of reliability obtained as results of consolidation are outputted from the image recognition unit 106 to the display control unit 107, and the display control unit 107 executes steps S809 to S812 for recognition results outputted from the image recognition unit 106.

The operation parameters set by the method shown in FIG. 7B may be used by the image recognition unit 106 or by the display control unit 107. The image recognition unit 106 may generate recognition results only for search results where the degree of similarity is greater than or equal to the threshold 711 in step S806, or the display control unit 107 may generate visual confirmation tasks only for recognition results where the degree of similarity is greater than or equal to the threshold 711 in step S811, for example.

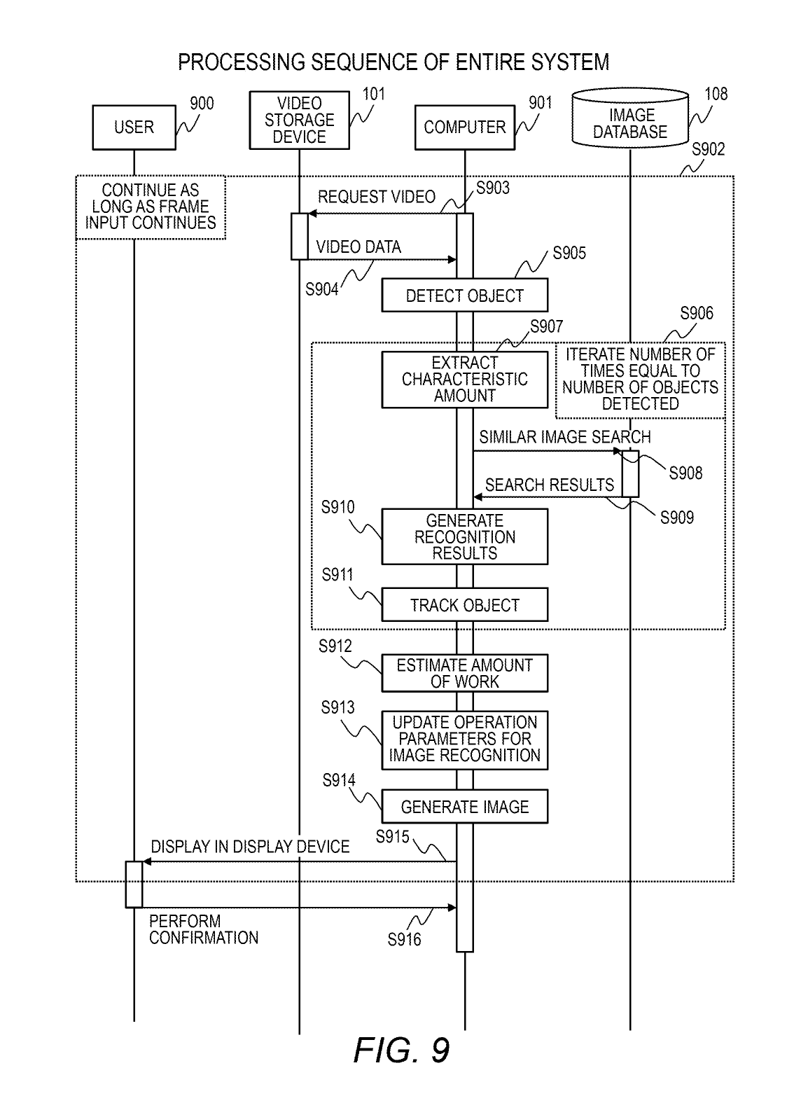

FIG. 9 is a drawing describing a process sequence of the video monitoring support system 100 according to Embodiment 1 of the present invention, and specifically shows a process sequence of the user 900, the video storage device 101, the computer 901, and the image database 108 in the image recognition and display processes of the video monitoring support system 100 described above. The computer 901 serves as the video monitoring support apparatus 104. The respective steps of FIG. 9 will be described below.

The computer 901 continuously executes step S902 as long as video is acquired from the video storage device 101. The computer 901 acquires video data from the video storage device 101 and, as necessary, converts the data format and extracts frames (S903-S904). The computer 901 extracts object regions from the obtained frames (S905). The computer 901 performs the image recognition process on the plurality of object regions that were obtained (S906). Specifically, the computer 901 first extracts characteristic amounts from the object regions (S907). Next, the computer 901 performs a similar image search on the image database 108, acquires the search results, and aggregates the search results to generate the recognition results (S908-S910). Lastly, the computer 901 associates the current recognition results with past recognition results to consolidate the recognition results (S911).

The computer 901 estimates the amount of work performed per unit time according to the newly generated recognition results and the past amount of work performed by the user, and updates the operation parameters for image recognition on the basis thereof (S912-S913). The computer 901 generates a display screen for user confirmation and displays it to the user 900 (S914-S915). The user 900 visually confirms recognition results displayed on the display screen and indicates whether to accept or reject the results to the computer 901 (S916). The confirmation work done by the user 900 and the recognition process S902 by the computer are performed simultaneously and in parallel. In other words, during the time from when the computer 901 displays to the user 900 the display screen for confirmation by the user (S915) to when the confirmation results are indicated to the computer 901 (S916), the next round of step S901 may be started.

FIG. 10 is a drawing that shows a configuration example of an operating screen for performing monitoring work aimed at finding a specific object being filmed using the video monitoring support apparatus 104 of Embodiment 1 of the present invention. The screen is displayed to the user on the display device 103. The user uses the input device 102 to operate a cursor 609 displayed on the screen to issue process commands to the video monitoring support apparatus 104.

The operating screen of FIG. 10 has an input video display region 1000, a confirmation task amount display region 1001, a display amount control setting region 1002, and a visual confirmation task display region 600.

The video monitoring support apparatus 104 displays the video acquired from the video storage device 101 as a live video in the input video display region 1000. If a plurality of pieces of video taken by different imaging devices (cameras) are acquired from the video storage device 101, then video may be displayed for each imaging device. The video monitoring support apparatus 104 displays the image recognition results in the visual confirmation task display region 600, and the user performs the visual confirmation task as previously described in FIG. 5. As long as video continues to be inputted, the video monitoring support apparatus 104 continues to generate video recognition results, and new visual confirmation tasks are added. In the example of FIG. 10, a plurality of visual confirmation tasks are displayed overlapping each other, but a predetermined number of tasks may be displayed simultaneously in a row. Also, the display size may be changed according to the importance of the task. Tasks for which visual confirmation by the user is completed are removed from the display screen. Also, tasks that have not been processed within a predetermined time may be automatically rejected. The number of tasks currently remaining and the amount of processing done per unit time are displayed in the confirmation task amount display region 1001.

When the user issues a command to control the display amount using the display amount control setting region 1002, the video monitoring support apparatus 104 controls the operation parameter for image recognition such that the amount of work processed is at or below a predetermined number (step S810 in FIG. 8). A setting may be added such that if the degree of reliability of image recognition is at or above a certain amount, then the task is displayed with priority even if this exceeds the set amount of tasks displayed.

According to Embodiment 1 of the present invention, it is possible to prevent overlooking of objects being monitored by setting the amount of visual confirmation tasks generated by the video monitoring support apparatus 104 to at or below a predetermined value such as a value determined on the basis of the amount of work done by the user or a value set by the user.

### Embodiment 2

In Embodiment 1, a method was described in which a certain amount of visual confirmation tasks were displayed to the user by controlling the operation parameter for image recognition according to the amount of work done by the user. However, during real time monitoring work, if the user confirms recognition results in chronological order, then if a more important object is newly detected, the user would not be able to handle such a case immediately. A video monitoring support apparatus 104 according to Embodiment 2 of the present invention is characterized in displaying visual confirmation tasks not in chronological order but in order of priority.

Aside from the differences described below, the various components of the video monitoring support system 100 of Embodiment 2 have the same functions as the components of Embodiment 1 that are displayed in FIGS. 1 to 10 and that are assigned the same reference characters, and thus, descriptions thereof are omitted.

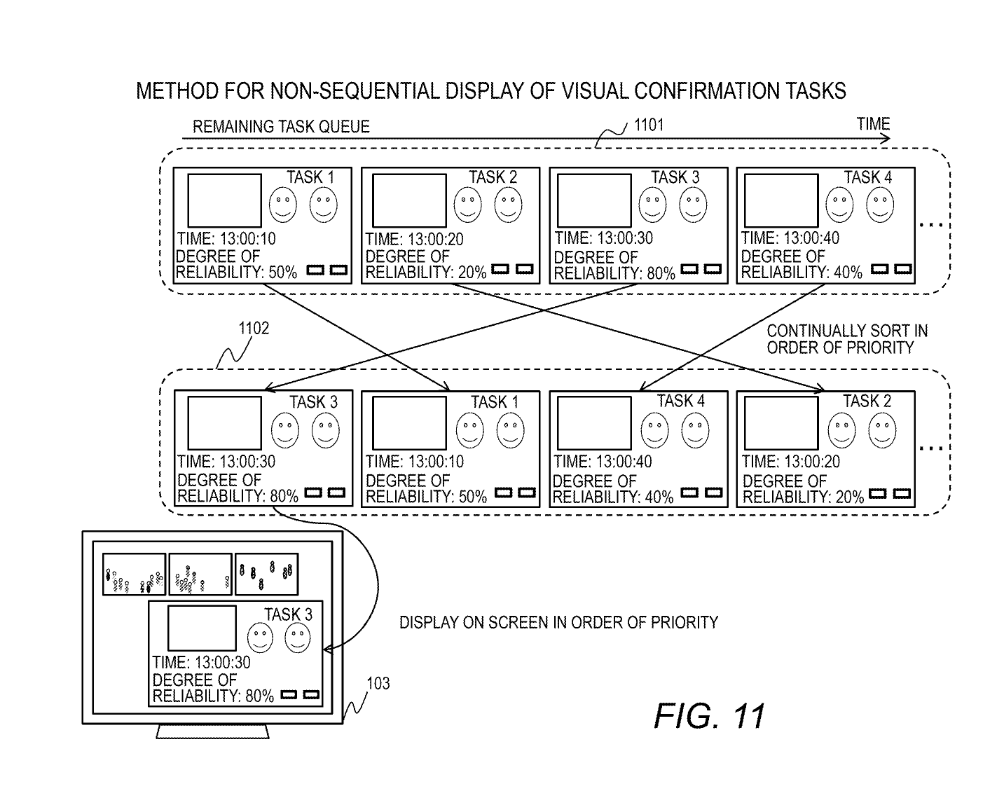

FIG. 11 is a drawing for describing a non-chronological display method for visual confirmation tasks performed by the video monitoring support system 100 of Embodiment 2 of the present invention.

The visual confirmation tasks generated by the image recognition unit 106 are added to a remaining task queue 1101 and are successively displayed in a display device 103 as visual confirmation work is completed by the user. If at this time a new visual confirmation task is added, the display control unit 107 immediately reorders the remaining tasks according to the order of priority (1102). All remaining tasks may be reordered or only tasks not currently displayed may be reordered. As the standard for reordering, the reliability of the recognition results may be used as the degree of priority, or the degree of priority of the recognition results corresponding to a predetermined attribute may be raised, for example. Specifically, a high degree of priority may be assigned to recognition results for a person who has a high degree of importance in the attribute information field 323, for example. Alternatively, the degree of priority may be determined on the basis of a combination of the degree of reliability and attribute value of the recognition results.

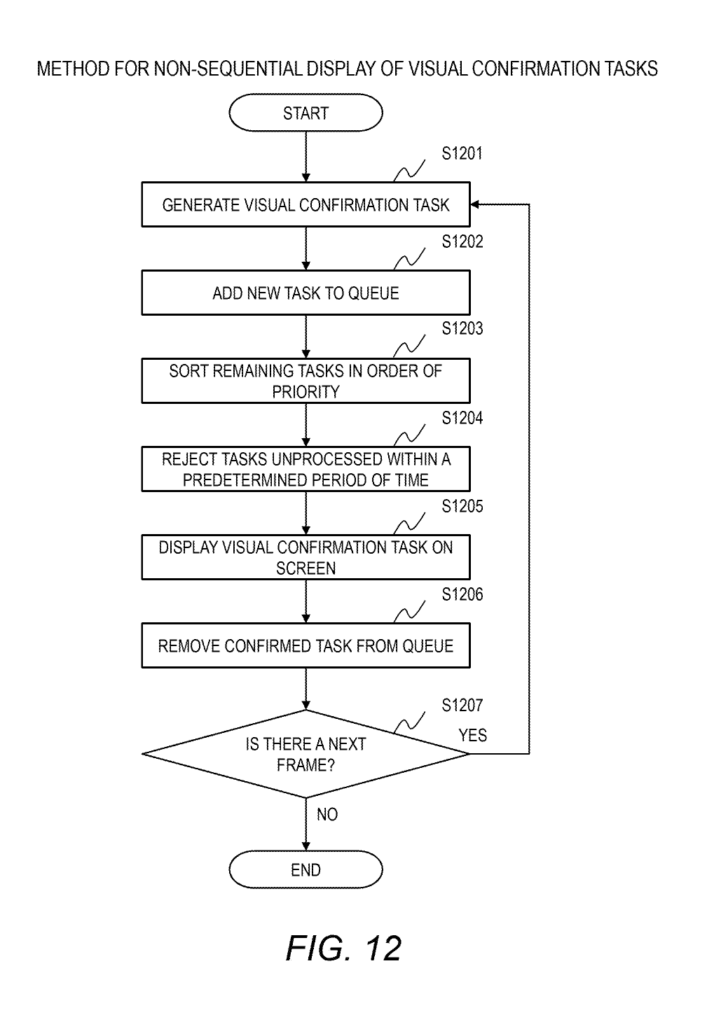

FIG. 12 is a flowchart for describing the process of a non-chronological display method for visual confirmation tasks performed by the video monitoring support system 100 of Embodiment 2 of the present invention. The respective steps of FIG. 12 will be described below.

(FIG. 12: Step S1201)

The display control unit 107 generates visual confirmation tasks according to the image recognition results generated by the image recognition unit 106. Step S1201 corresponds to steps S801 to S811 of FIG. 8.

(FIG. 12: Step S1202)

The display control unit 107 adds the visual confirmation tasks added in step 1201 to a display queue 1101.

(FIG. 12: Step S1203)

The display control unit 107 reorders the remaining tasks stored in the display queue 1101 according to the degree of priority. As described previously, the degree of reliability or an attribute value of the recognition results can be used as the order of priority.

(FIG. 12: Step S1204)

The display control unit 107 rejects tasks if the number of remaining tasks in the display queue 1101 is greater than or equal to a predetermined number, or if the task has not been processed for a predetermined time (that is, tasks for which a predetermined time has elapsed since being generated). If the number of remaining tasks is greater than or equal to the predetermined number, the display control unit 107 selects a number of remaining tasks beyond the predetermined number in order from the end of the queue 1101 and rejects them. In this manner, one or more tasks are rejected in order of least priority first. The rejected tasks may be saved in the database to be viewed later.

(FIG. 12: Step S1205)

The display control unit 107 displays the visual confirmation tasks in the display device 103 starting from the head of the queue 1101 (that is, in order of highest priority). At this time a plurality of visual confirmation tasks may be simultaneously displayed.

(FIG. 12: Step S1206)

The display control unit 107 deletes tasks for which the user has performed the confirmation task from the queue 1101.

(FIG. 12: Step S1207)

If input of the next frame is received from the video storage device 101, the video monitoring support apparatus 104 returns to step S1201 and continues to execute the above processes. Otherwise, the process is ended.

According to Embodiment 2 of the present invention, it is possible to confirm with priority images with the greatest need to be visually confirmed, such as images that have a high probability of being of an object being monitored or images that have a high probability of being of an object being monitored having a high degree of importance, regardless of the order in which the images were recognized.

### Embodiment 3

In Embodiment 3 below, a process for when a plurality of video sources are inputted from the video storage device 101 such as an operation in which a video monitoring system of the present invention is applied to video taken by monitoring cameras set in a plurality of locations will be described.

Aside from the differences described below, the various components of the video monitoring support system 100 of Embodiment 3 have the same functions as the components of Embodiment 1 that are displayed in FIGS. 1 to 10 and that are assigned the same reference characters, and thus, descriptions thereof are omitted.

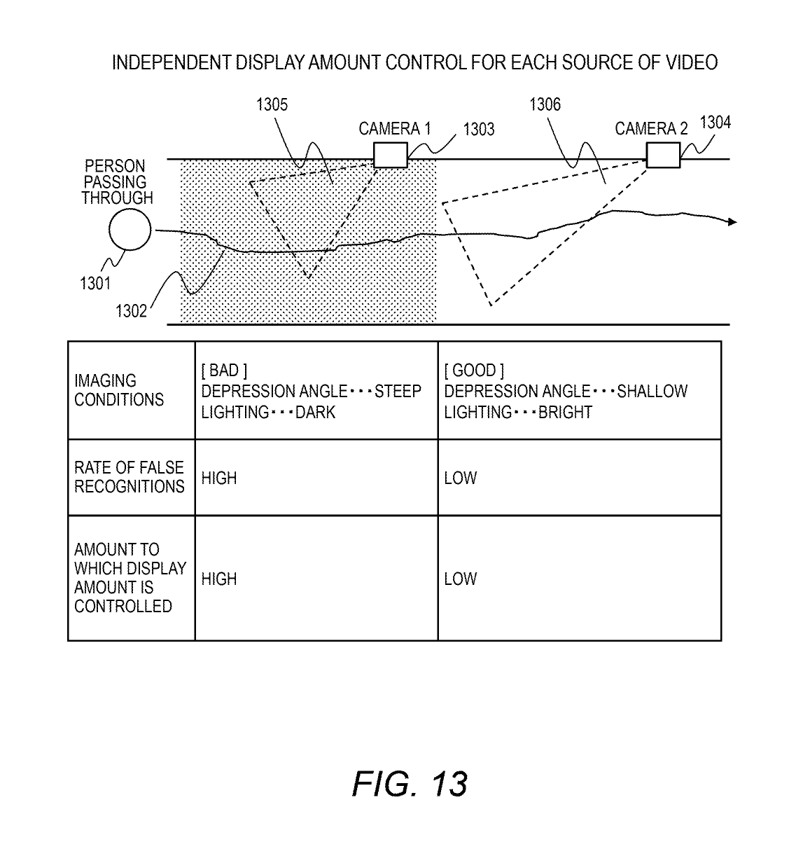

FIG. 13 is a drawing for describing a display amount control method with independent video sources performed by the video monitoring support system 100 of Embodiment 3 of the present invention.

FIG. 13 shows a state in which a camera 1303 and a camera 1304 are installed in adjacent locations and are imaging ranges 1305 and 1306. A person 1301 passing through moves on a path 1302 and is imaged by the camera 1303 and the camera 1304. At this time, for example, the camera 1303 is in dark lighting conditions, and the angle of depression is deep, which makes it difficult for the camera to take video suited to image recognition, which increases the probability of false recognition visual confirmation tasks being generated. On the other hand, the camera 1304 has good imaging conditions, which reduces the rate of false recognitions. A person being monitored need only be detected by a user once from the cameras in the plurality of locations. Thus, the video monitoring support system 100 controls the operation parameters for image recognition such that the amount of visual confirmation tasks displayed is reduced for video sources with bad imaging conditions (that is, with a high rate of false recognitions), and such that the amount of visual confirmation tasks displayed is increased for video sources with good imaging conditions (that is, with a low rate of false recognitions). Thus, it is easier for recognition results for images with a low rate of false recognitions to be outputted compared to recognition results for images with a high rate of false recognitions.

The video monitoring support apparatus 104 has operation parameters for recognizing images taken by each camera. A configuration may be adopted in which information identifying the camera that has taken the video is included in the video data inputted from the video storage device 101 to the video input unit 105, and the video monitoring support apparatus 104 uses the operation parameters corresponding, respectively, to the cameras that have taken the video to execute image recognition, for example. Specific controls of operation parameters and processes that use these controls can be performed by a method similar to Embodiment 1 as shown in FIGS. 7A, 7B, 8, etc.

Whether the imaging conditions are good or bad may be inputted by the user to the system, or may be determined by automatically calculating the false recognition rate according to work results. A configuration may be adopted in which the user estimates the false recognition rate on the basis of imaging conditions for each camera and inputs the false recognition rate, and the video monitoring support apparatus 104 controls the operation parameters according to the false recognition rate for each camera (that is, such that the amount of visual confirmation tasks is smaller for cameras with a higher false recognition rate), for example. Alternatively, a configuration may be adopted in which the user inputs the imaging conditions (such as the lighting conditions and depression angle of the installed camera, for example) for each camera, and the video monitoring support apparatus 104 calculates the false recognition rate for each camera on the basis of the imaging conditions and controls the operation parameters for each camera according to this false recognition rate. Alternatively, the video monitoring support apparatus 104 may calculate the false recognition rate for each camera on the basis of visual confirmation task results by the user (specifically, whether the user operated the recognition result accept button 507 or the recognition result reject button 508) for images taken by the respective cameras, and control the operation parameters for the respective cameras according to the calculated false recognition rate.

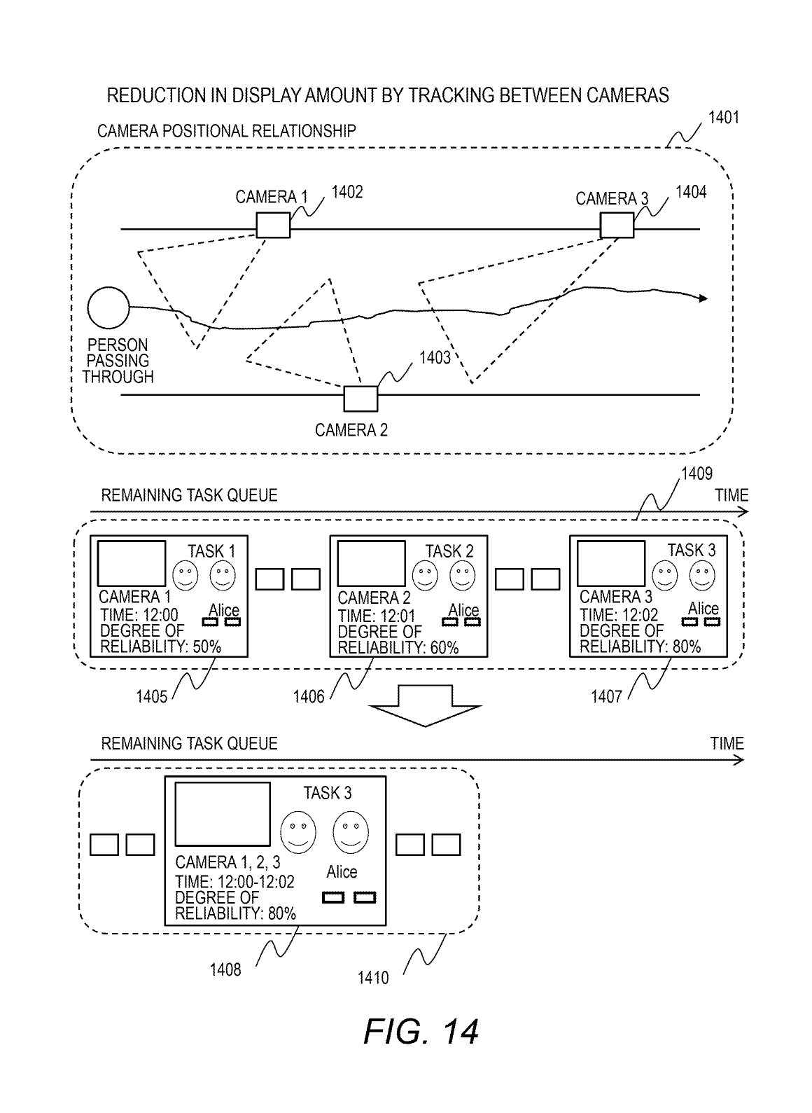

FIG. 14 is a drawing for describing a consolidation method for visual confirmation tasks generated from video taken at a plurality of locations, performed by the video monitoring support system 100 of Embodiment 3 of the present invention.

In FIG. 14, the camera 1402, the camera 1403, and the camera 1404 are installed according to the shown positional relationship 1401. As a result of visual confirmation tasks being generated from video data acquired from the plurality of video sources such as cameras 1402 to 1404, results 1405, 1406, and 1407 having the same attributes and generated from differing video sources are stored in the remaining task queue 1409. In this example, the results 1405, 1406, and 1407 respectively include recognition results for images taken by the cameras 1402, 1403, and 1404. The video monitoring support system 100 consolidates the recognition results of individual video sources, thereby consolidating the recognition results 1408 of a plurality of video sources. In this manner, the remaining task queue 1410 after consolidation can be made shorter than the remaining task queue 1409 prior to consolidation.

As a consolidation method, a method in which a determination is made according to attribute values of recognition results, time, and the positional relationships between the plurality of cameras can be adopted, for example. Specifically, a method may be used in which the relationship between the positions in images taken by the cameras and the position in real space is identified on the basis of the positional relationships identified according to the installation conditions of the cameras, and objects having the same attribute value and at the same location at the same time are determined to be the same object on the basis of recognition results of images taken by the plurality of cameras, for example. Alternatively, an object tracking method between images taken by one camera, described in FIG. 6, may be applied to tracking of an object between images taken by different cameras.

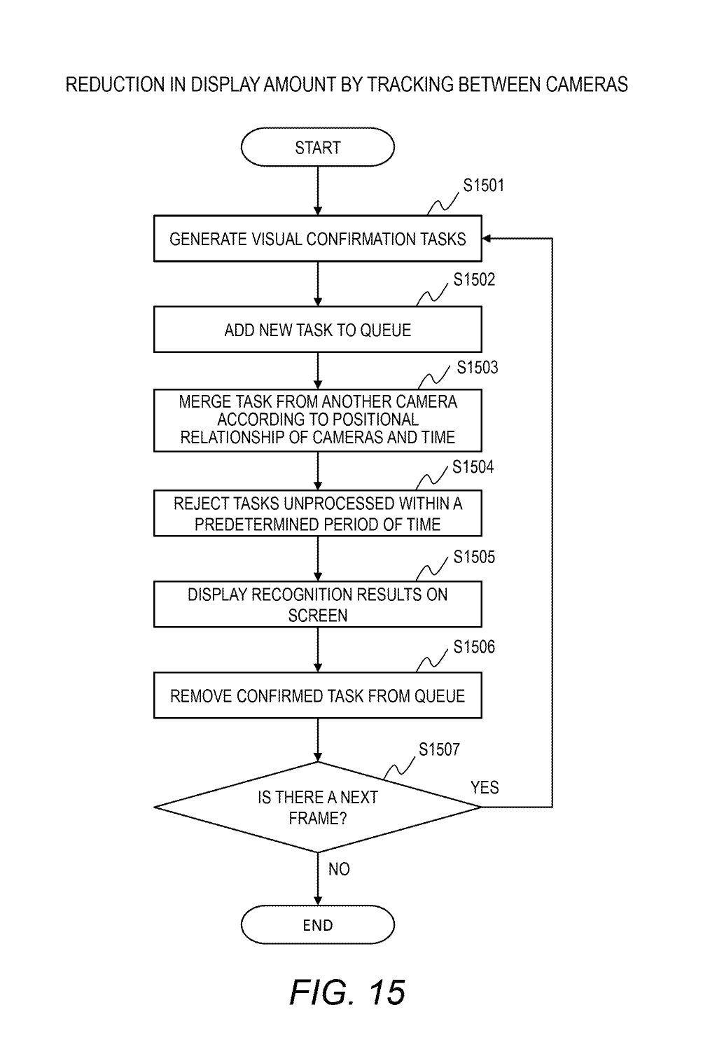

FIG. 15 is a flowchart for describing a consolidation method for visual confirmation tasks generated from video taken at a plurality of locations, performed by the video monitoring support system 100 of Embodiment 3 of the present invention. The respective steps of FIG. 15 will be described below.

(FIG. 15: Step S1501)

The display control unit 107 generates visual confirmation tasks according to the image recognition results generated by the image recognition unit 106. Step S1501 corresponds to steps S801 to S811 of FIG. 8.

(FIG. 15: Step S1502)

The display control unit 107 adds the visual confirmation tasks added in step 1501 to a display queue 1409.

(FIG. 15: Step S1503)

The display control unit 107 consolidates visual confirmation tasks from individual video sources to a visual confirmation task of a plurality of video sources.

(FIG. 15: Step S1504)

The display control unit 107 rejects tasks if the number of remaining tasks in the display queue 1410 is greater than or equal to a predetermined number, or if the task has not been processed for a predetermined time. This rejection may be performed in a manner similar to that of step S 1204 in FIG. 12. The rejected tasks may be saved in the database to be viewed later.

(FIG. 15: Step S1505)

The display control unit 107 displays the visual confirmation tasks in the display device 103 starting from the head of the queue 1410. At this time a plurality of visual confirmation tasks may be simultaneously displayed.

(FIG. 15: Step S1506)

The display control unit 107 deletes tasks for which the user has performed the confirmation task from the queue 1410.

(FIG. 15: Step S1507)

If input of the next frame is received from the video storage device 101, the video monitoring support apparatus 104 returns to step S1501 and continues to execute the above processes. Otherwise, the process is ended.

According to Embodiment 3 of the present invention, by controlling the operation parameters such that the amount of visual confirmation tasks generated from images estimated to have a high false recognition rate due to installation conditions of the cameras or the like is low, it is possible for the user to dedicate processing capabilities towards visual confirmation of images estimated to have a low false recognition rate, which allows for prevention of missing objects to be monitored. Also, by increasing the range of consolidation, it is possible for the user to dedicate his/her processing capabilities to visual confirmation of images having a low probability of having the same object as another image, which enables prevention of overlooking of images containing objects being monitored.

### Embodiment 4

In Embodiments 2 and 3, old confirmation tasks that the user was unable to process within a predetermined time were rejected according to the order of priority. In Embodiment 4 below, the means for rejecting tasks while preserving diversity will be described.

Aside from the differences described below, the various components of the video monitoring support system 100 of Embodiment 4 have the same functions as the components of Embodiment 1 that are displayed in FIGS. 1 to 10 and that are assigned the same reference characters, and thus, descriptions thereof are omitted.

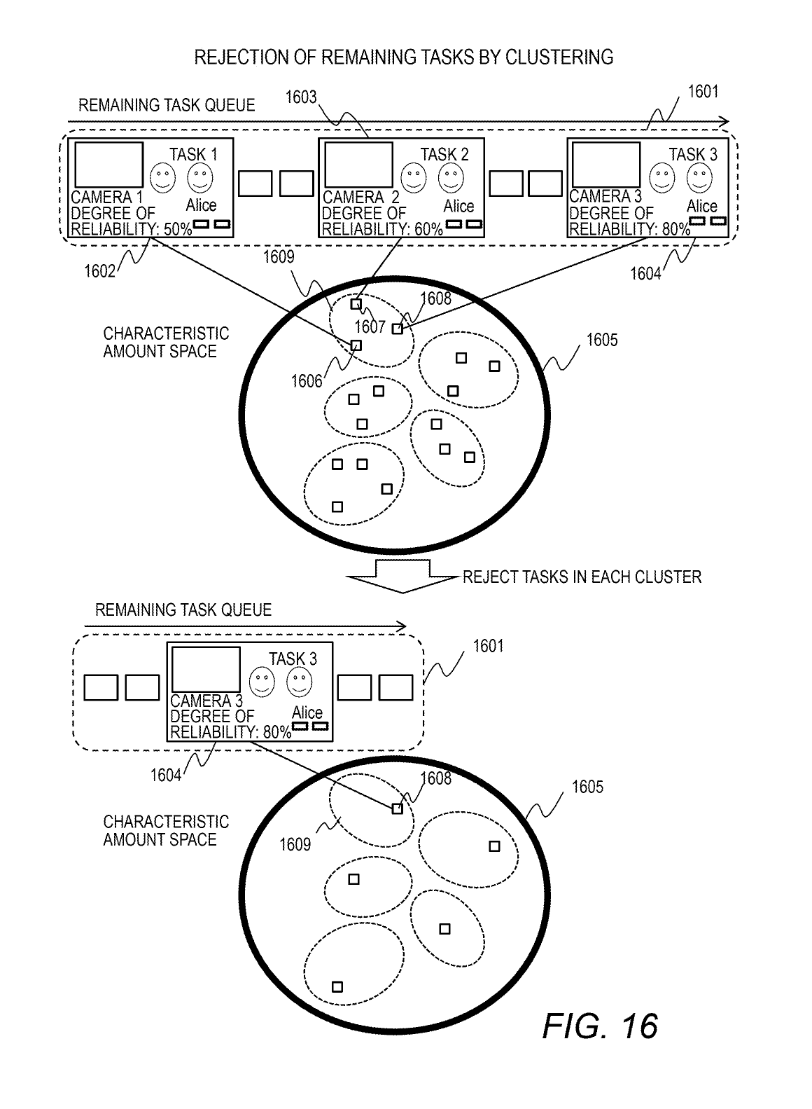

FIG. 16 is a drawing for describing a method for rejecting remaining tasks by clustering performed by the video monitoring support system 100 of Embodiment 4 of the present invention.

When a new task is added to the visual confirmation task queue 1601, the video monitoring support apparatus 104 extracts characteristic amounts from the task, and stores them in a primary storage region (a portion of a storage region of the storage device 202, for example). Characteristic amounts used in image recognition may be used as is, or attribute information of the recognition results may be used as the characteristic amounts. Every time a task is added, the video monitoring support apparatus 104 clusters the characteristic amounts. A publicly known method such as K-MEANS clustering can be used as the clustering method, for example. As a result, multiple clusters having a plurality of tasks as members are formed. From the tasks 1602, 1603, and 1604 included in the queue 1601, for example, characteristic amounts 1606, 1607, and 1608 are generated, and a cluster 1609 including these is formed in a characteristic amount space 1605, for example. If the total number of tasks exceeds a certain amount, the video monitoring support apparatus 104 leaves remaining a certain number of tasks, which are members of each cluster, while rejecting the rest. Clustering may be executed only when the amount of tasks exceeds a certain amount. Among the members belonging to the cluster 1609, the task 1604 with the highest degree of reliability is left remaining, with the rest being rejected. Tasks being rejected may be determined according to the degree of priority as in Embodiment 2.

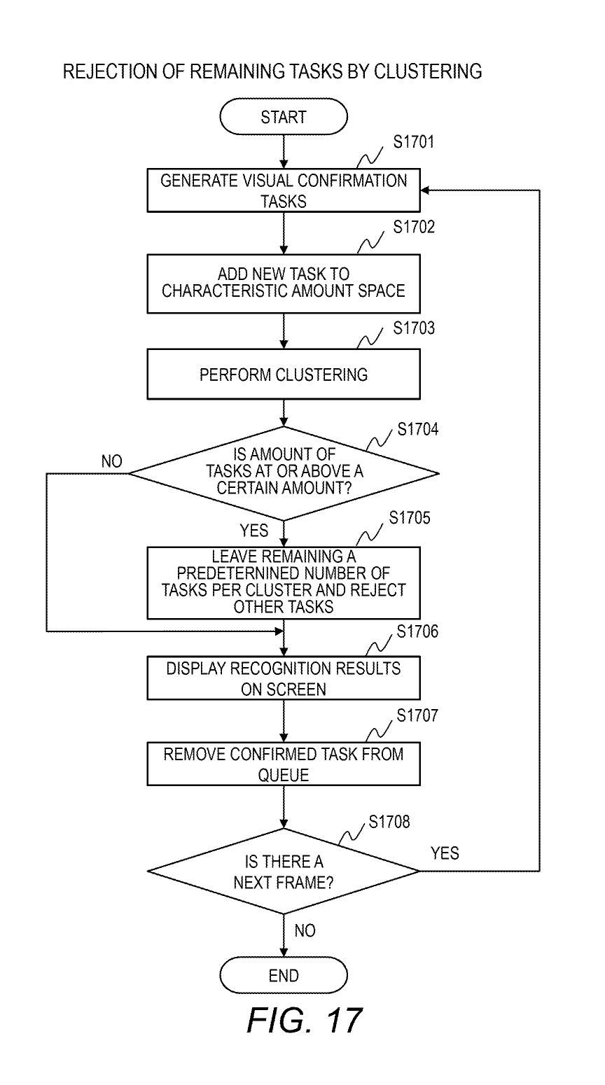

FIG. 17 is a flowchart for describing a method for rejecting remaining tasks by clustering performed by the video monitoring support system 100 of Embodiment 4 of the present invention. The respective steps of FIG. 17 will be described below.

(FIG. 17: Step S1701)

The display control unit 107 generates visual confirmation tasks according to the image recognition results generated by the image recognition unit 106. Step S1701 corresponds to steps S801 to S811 of FIG. 8.

(FIG. 17: Step S1702)

The display control unit 107 adds characteristic amounts of newly added tasks to the characteristic amount space 1605.

(FIG. 17: Step S1703)

The display control unit 107 clusters tasks on the basis of characteristic amounts held in the characteristic amount space 1605.

(FIG. 17: Step S1704)

If the amount of tasks is at or above a certain amount, the display control unit 107 progresses to step S1705, and if not, executes step S1706.

(FIG. 17: Step S1705)

The display control unit 107 leaves remaining a predetermined number of tasks in each cluster formed in the characteristic amount space and rejects the remaining tasks.

(FIG. 17: Step S1706)

The display control unit 107 displays the visual confirmation tasks in the display device 103 starting from the head of the queue 1601. At this time a plurality of visual confirmation tasks may be simultaneously displayed.

(FIG. 17: Step S1707)

The display control unit 107 deletes tasks for which the user has performed the confirmation task from the queue 1601. At the same time, characteristic amounts corresponding to the deleted tasks are deleted from the characteristic amount space.

(FIG. 17: Step S1708)

If input of the next frame is received from the video storage device 101, the video monitoring support apparatus 104 returns to step S1501 and continues to execute the above processes. Otherwise, the process is ended.

Tasks classified in the same cluster as a result of clustering have a high probability of being tasks pertaining to images of the same person. Additionally, clustering based on image characteristic amounts can be performed for images taken by a plurality of cameras even if the positional relationships between cameras is unclear. According to Embodiment 4 of the present invention, by restricting the number of visual confirmation tasks per cluster to within a predetermined number, it is possible for the user to dedicate his/her processing capabilities to visual confirmation of images having a low probability of having the same object as another image, which enables prevention of overlooking of images containing objects being monitored.

### Embodiment 5

In Embodiments 2 to 4, the flow amount for visual confirmation tasks was restricted to within a predetermined amount without making the user aware of the content of remaining tasks or tasks that were rejected due to low degree of priority. On the other hand, there are applications where overlooking of a person of interest is a greater problem than a delay in discovering such a person, or applications where it is not desirable to modify operation parameters pertaining to whether or not the person should be subject to visual confirmation. A video monitoring support apparatus 104 according to Embodiment 5 of the present invention is characterized in that a plurality of operation parameters are set in stages, the display screen is divided into a plurality of regions, and visual confirmation tasks or remaining tasks according to operation parameters are displayed in each region.

Aside from the differences described below, the various components of the video monitoring support system of Embodiment 5 have the same functions as the components of Embodiment 1 that are assigned the same reference characters, and thus, descriptions thereof are omitted. For ease of understanding, in the description of this embodiment, it is assumed that there is only a threshold 711 for degree of similarity, and there are three thresholds A, B, and C (where A<B>C, and the relationship between A and C is arbitrary).

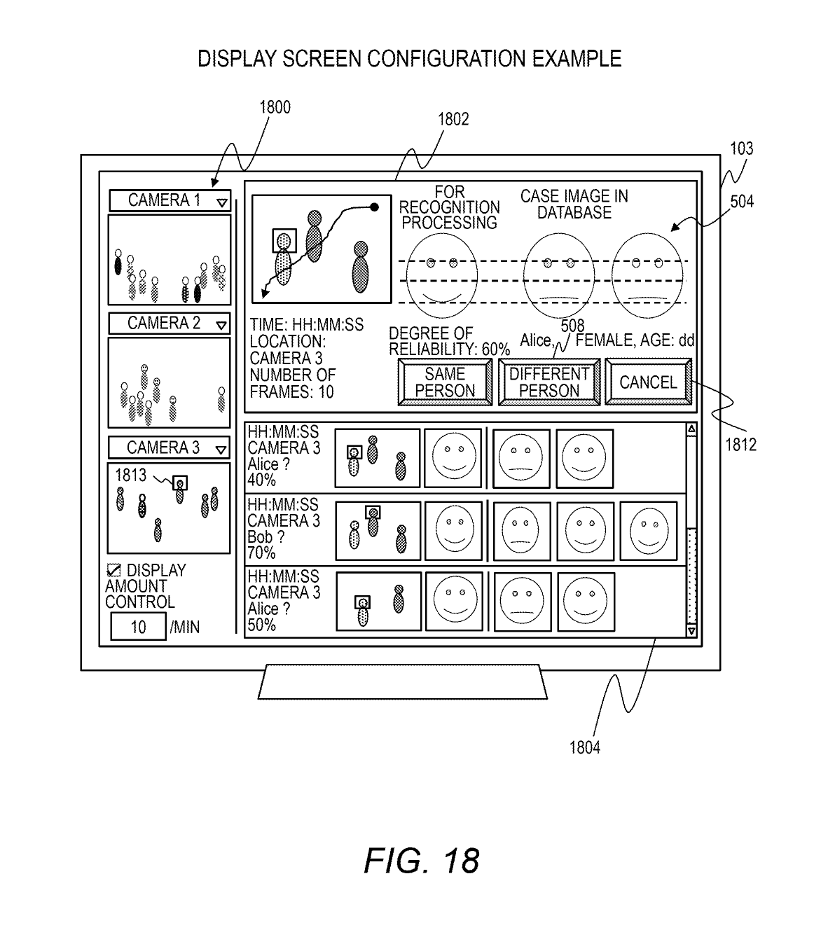

FIG. 18 is a drawing that shows a configuration example of an operating screen for performing monitoring work aimed at finding a specific object being filmed using the video monitoring support apparatus 104 of Embodiment 5 of the present invention. The operating screen of FIG. 18 has an input video display region 1800, a visual confirmation task display operation region 1802, and a remaining task summary display region 1804.

The input video display region 1800 is a region where a plurality of live feeds taken by a plurality of imaging devices are displayed. If there are recognition results where the threshold is greater than or equal to A prior to or during recognition result consolidation (S807), the video monitoring support apparatus 104 displays over these live feeds a frame 1813 corresponding to an object region (circumscribed rectangle) detected in S802 when the recognition results were received.

The visual confirmation task display operation region 1802 is a region corresponding to the visual confirmation task display region 600 where the oldest visual confirmation task outputted from the queue (not shown) among visual confirmation tasks having a threshold of B or greater is displayed. If a plurality of cases are stored in the case table 310 for one individual ID recognized to be the most similar, the video monitoring support apparatus 104 of the present embodiment displays in the case image display region 504 the images of those cases as the in-database case images. If there are more cases than images that can be displayed simultaneously, the excess case images are displayed in the form of an automatic slide show.

Also, in the vicinity of the case image display region 504, a plurality of pieces of useful attribute information within the individual IDs read from the individual information table 320 are displayed. Additionally, a determination suspension button 1812 is provided near the recognition result reject button 508, and recognition results for which the determination suspension button 1812 is pressed are either inputted again in the queue 1810 as visual confirmation tasks or moved to a task list to be mentioned later (not shown). Tasks rejected in Embodiments 1 to 4 are also moved to the task list.

The remaining task summary display region 1804 is a region that enables display by scrolling of all visual confirmation tasks held in the task list for which the threshold is C or greater. The task list of the present embodiment is sorted in descending order by attribute information 323 (degree of importance) of the person, and confirmation tasks having the same attribute information 323 (degree of importance) are sorted in descending order by time. If scrolling is not done for a predetermined time or greater, then the list is automatically scrolled up to the top of the list, and as many as possible of tasks that are of high importance and new are displayed in the display region 1804.

Similar to the visual confirmation task display region 600, for each confirmation task, the name of the person corresponding to the recognized individual ID, the degree of reliability of recognition, the frame where the image recognition results were acquired, an image of the object, the case image, and the like are displayed, but the image size is smaller than that displayed in the visual confirmation task display operation region 1802. Each confirmation task is displayed such that the degree of importance is distinguishable by color or the like. When a predetermined operation (double click or the like) is performed by the input device 102 in the display region for individual confirmation tasks, the confirmation tasks are moved to the oldest task in the queue. The task list may be configured like the queue 1102 of Embodiment 2 as necessary such that old tasks that do not satisfy a predetermined degree of priority are rejected.

According to the present embodiment, even if there is a temporary increase in the number of visual confirmation tasks, a relatively long time buffer is provided, and thus, tasks are not rejected before the user notices. In other words, this buffering compensates for the frequency in which tasks are generated and individual differences in users' work performance, which eliminates the need for extreme dynamic control of operation parameters.

The present invention is not limited to the embodiment above, and includes various modification examples. The embodiment above was described in detail in order to explain the present invention in an easy to understand manner, but the present invention is not necessarily limited to including all configurations described, for example. It is possible to replace a portion of the configuration of one embodiment with the configuration of another embodiment, and it is possible to add to the configuration of the one embodiment a configuration of another embodiment. Furthermore, other configurations can be added or removed, or replace portions of the configurations of the respective embodiments.

Some or all of the respective configurations, functions, processing units, processing means, and the like may be realized with hardware such as by designing an integrated circuit, for example. Additionally, the respective configurations, functions, and the like can be realized by software by the processor interpreting programs that execute the respective functions and executing such programs. Programs, data, tables, files, and the like realizing respective functions can be stored in a storage device such as memory, a hard disk drive, or a solid state drive (SSD), or in a computer-readable non-transitory data storage medium such as an IC card, an SD card, or a DVD.

Control lines and data lines regarded as necessary for explanation of the embodiments are shown in the drawings, but not all control lines and data lines included in a product to which the present invention is applied have necessarily been shown. In reality, almost all components can be thought of as connected to each other.

What is claimed is:

1. A video monitoring support apparatus, comprising:
a processor; and
a storage device coupled to the processor,
wherein the storage device stores a plurality of images, and
wherein the video monitoring support apparatus is configured to:
execute a similar image search in which an image similar to an image extracted from inputted video from among the plurality of images stored in the storage device;
output a plurality of recognition results including information pertaining to images acquired by the similar image search; and
control an amount of the recognition results outputted so as to be at or below a predetermined value.

2. The video monitoring support apparatus according to claim 1,
wherein the video monitoring support apparatus is configured to control an operation parameter of the similar image search such that the amount of the recognition results outputted per unit time is at or below an amount that a user processes per unit time for the plurality of already outputted recognition results, thereby controlling the amount of outputted recognition results so as to be at or below the predetermined value.

3. The video monitoring support apparatus according to claim 2,
wherein the video monitoring support apparatus is configured to:
determine whether a plurality of images extracted from a plurality of frames included in the inputted video are of a same object;
output the recognition results for a predetermined number of images among a plurality of images determined to be of the same object; and
control conditions for determining whether the plurality of images extracted from the plurality of frames are of the same object, thereby controlling the amount of outputted recognition results so as to be at or below the predetermined value.

4. The video monitoring support apparatus according to claim 3,
wherein a plurality of pieces of video taken by different imaging devices are inputted to the video monitoring support apparatus, and
wherein the video monitoring support apparatus is configured to determine whether the plurality of images extracted from the plurality of frames included in the plurality of pieces of video are of the same object, on the basis of recognition results for the plurality of images extracted from the plurality of frames included in the plurality of pieces of video, installation conditions for the respective imaging devices, and an imaging time for each piece of video.

5. The video monitoring support apparatus according to claim 2,
wherein a plurality of pieces of video taken by different imaging devices are inputted to the video monitoring support apparatus,
wherein the process performed by the user for the recognition results is for determining whether the images extracted from the inputted video are of the same object as images acquired by the similar image search, and
wherein the video monitoring support apparatus is configured to:
estimate a false recognition rate of the recognition results for each of the imaging devices on the basis of imaging conditions of the imaging devices or results of the process performed by the user; and
control the output of the recognition results such that recognition results for images extracted from video taken by imaging devices in which the estimated false recognition rate is low are more likely to be outputted.

6. The video monitoring support apparatus according to claim 2,
wherein the video monitoring support apparatus is configured to:
store a plurality of recognition results that were generated but not yet outputted;
determine degrees of priority of the recognition results on the basis of at least one of the degree of reliability of the recognition results and attribute values assigned in advance to the images stored in the storage device;
output the plurality of recognition results in order from the highest degree of priority; and
delete, if an elapsed time from when any of the stored recognition results were generated or a number of said stored recognition results satisfies a predetermined condition, one or more said recognition results in order from the lowest degree of priority.

7. The video monitoring support apparatus according to claim 2,
wherein the video monitoring support apparatus is configured to:
store a plurality of recognition results that were generated but not yet outputted;
cluster the plurality of recognition results on the basis of characteristic amounts extracted from the recognition results; and
delete recognition results other than a predetermined number of recognition results included in each cluster.

8. A video monitoring support method executed by a video monitoring support apparatus having: a processor; and a storage device coupled to the processor,
wherein the storage device stores a plurality of images, and
wherein the video monitoring support method comprises:
a first step of searching an image similar to an image extracted from inputted video from among the plurality of images stored in the storage device;
a second step of outputting a plurality of recognition results including information pertaining to images acquired by the first step; and
a third step of controlling an amount of the recognition results outputted so as to be at or below a predetermined value.

9. The video monitoring support method according to claim 8,
wherein the third step includes a step of controlling an operation parameter of the similar image search such that the amount of the recognition results outputted per unit time is at or below an amount that a user processes per unit time for the plurality of already outputted recognition results.

10. The video monitoring support method according to claim 9, further comprising:
a step of determining whether a plurality of images extracted from a plurality of frames included in the inputted video are of a same object,
wherein the second step includes a step of outputting the recognition results for a predetermined number of images among a plurality of images determined to be of the same object, and
wherein the third step includes a step of controlling conditions for determining whether the plurality of images extracted from the plurality of frames are of the same object, thereby controlling the amount of outputted recognition results so as to be at or below the predetermined value.

11. The video monitoring support method according to claim 10,
wherein a plurality of pieces of video taken by different imaging devices are inputted to the video monitoring support apparatus, and
wherein the video monitoring support method further includes a step of determining whether the plurality of images extracted from the plurality of frames included in the plurality of pieces of video are of the same object, on the basis of recognition results for the plurality of images extracted from the plurality of frames included in the plurality of pieces of video, installation conditions for the respective imaging devices, and an imaging time for each piece of video.

12. The video monitoring support method according to claim 9,
wherein a plurality of pieces of video taken by different imaging devices are inputted to the video monitoring support apparatus,
wherein the process performed by the user for the recognition results is for determining whether the images extracted from the inputted video are of the same object as images acquired by the similar image search, and
wherein the third step includes a step of estimating a false recognition rate of the recognition results for each of the imaging devices on the basis of imaging conditions of the imaging devices or results of the process performed by the user, and controlling the output of the recognition results such that recognition results for images extracted from video taken by imaging devices in which the estimated false recognition rate is low are more likely to be outputted.

13. The video monitoring support method according to claim 9,
wherein the video monitoring support apparatus stores a plurality of search results that were generated but not yet outputted, and
wherein the video monitoring support method further comprises:
a step of determining degrees of priority of the recognition results on the basis of at least one of the degree of reliability of the recognition results and attribute values assigned in advance to the images stored in the storage device;
a step of outputting the plurality of recognition results in order from the highest degree of priority; and
a step of deleting, if an elapsed time from when any of the stored recognition results were generated or a number of said stored recognition results satisfies a predetermined condition, one or more said recognition results in order from the lowest degree of priority.

14. The video monitoring support method according to claim 9,
wherein the video monitoring support apparatus stores a plurality of recognition results that were generated but not yet outputted, and
wherein the video monitoring support method further comprises:
a step of clustering the plurality of recognition results on the basis of characteristic amounts extracted from the recognition results; and
a step of deleting recognition results other than a predetermined number of recognition results included in each cluster.

15. A non-transitory computer-readable storage medium that stores programs that control the computer,
wherein the computer has: a processor; and a storage device coupled to the processor,
wherein the storage device stores a plurality of images, and
wherein the program causes the processor to execute:
a first step of searching an image similar to an image extracted from inputted video from among the plurality of images stored in the storage device;
a second step of outputting a plurality of recognition results including information pertaining to images acquired by the first step; and
a third step of controlling an amount of the recognition results outputted so as to be at or below a predetermined value.
